(19) United States
(12) Patent Application Publication
(10) Pub. No.: US 2025/0105879 A1
(43) Pub. Date: Mar. 27, 2025

(54) Communications Systems for Leveraging Beam Squint Effects

(71) Applicant: Apple Inc., Cupertino, CA (US)

(72) Inventors: Wanlu Sun, San Diego, CA (US); Sharad Sambhwani, San Diego, CA (US); Ioannis Sarkas, San Carlos, CA (US)

(21) Appl. No.: 18/781,077

(22) Filed: Jul. 23, 2024

Related U.S. Application Data
(60) Provisional application No. 63/585,102, filed on Sep. 25, 2023.

(51) Int. Cl. H04B 7/04; H04B 7/0426; H04B 7/06; H04W 52/26

(52) U.S. Cl. CPC H04B 7/04013; H04B 7/043; H04B 7/06952; H04W 52/26

(57) ABSTRACT

A communication system may include a wireless base station (BS), one or more user equipment (UE) devices, and optionally one or more reconfigurable intelligent surfaces (RIS's). Phased antenna arrays may be implemented on one or more of these devices. The phased antenna arrays may exhibit beam squint. The beam squint may be leveraged to optimize communications efficiency in the system. For example, a transmit device may leverage beam squint to perform modulation coding scheme (MCS) adjustment, transmit power level adjustment, reference signal allocation, beam width adjustment, frequency domain resource allocation, carrier aggregation band selection, and/or beam management procedures. Beam squint may also be leveraged to ensure that satisfactory communications are maintained between the BS and the UE devices even as the UE devices move over time.

This application claims the benefit of U.S. Provisional Patent Application No. 63/585,102, filed Sep. 25, 2023, which is hereby incorporated by reference herein in its entirety.

### FIELD

This disclosure relates generally to electronic devices, including electronic devices with wireless circuitry.

### BACKGROUND

Electronic devices are often provided with wireless capabilities. An electronic device with wireless capabilities has wireless circuitry that includes one or more antennas. The antennas can be arranged in arrays that convey radio-frequency signals.

As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight. In addition, antennas arranged in arrays can exhibit beam squinting effects. If care is not taken, the beam squinting effects can limit wireless performance.

### SUMMARY

A communication system may include a wireless base station (BS), one or more user equipment (UE) devices, and optionally one or more reconfigurable intelligent surfaces (RIS's). Phased antenna arrays may be implemented on one or more of these devices. The phased antenna arrays may exhibit beam squint where the arrays exhibit peak gains in different directions at different frequencies within a bandwidth. The beam squint may be leveraged to optimize communications efficiency in the system.

For example, a transmit device may leverage beam squint to perform modulation coding scheme (MCS) adjustment, transmit power level adjustment, reference signal allocation, beam width adjustment, frequency domain resource allocation, carrier aggregation band selection, and/or beam management procedures for wireless signals transmitted over a transmit beam of the transmit device. Beam squint may also be leveraged to ensure that satisfactory communications are maintained between the BS and the UE devices even as the UE devices move over time. For example, the sub-band allocation of transmitted signals can be adjusted without changing phase and magnitude settings of the array and/or without changing reflection coefficient settings of the RIS to allow the transmitted signals to continue to reach a UE device that has moved over time. The sub-bands can be reallocated based on angle-of-departure changes predicted at the UE device and/or at the BS.

### BRIEF DESCRIPTION OF THE DRAWINGS

FIG. 1 is a schematic block diagram of an illustrative communications system having an electronic device that conveys wireless signals with an external device directly or via a reconfigurable intelligent surface (RIS) in accordance with some embodiments.

FIG. 2 is a diagram showing how an illustrative electronic device, RIS, and external device may communicate using both a data transfer radio access technology (RAT) and a control RAT in accordance with some embodiments.

FIG. 3 is a circuit schematic diagram of an illustrative RIS that redirects wireless signals in accordance with some embodiments.

FIG. 4 is a cross-sectional diagram of an illustrative RIS implemented as a reconfigurable holographic surface (RHS) in accordance with some embodiments.

FIG. 5 is a schematic diagram of an illustrative phased antenna array in accordance with some embodiments.

FIG. 6 is a diagram showing how an illustrative transmit device having a phased antenna array may transmit wireless signals to an illustrative receive device over a transmit beam oriented at a corresponding angle-of-departure (AOD) in accordance with some embodiments.

FIG. 7 includes plots showing how an illustrative phased antenna array can exhibit beam squinting effects in accordance with some embodiments.

FIG. 8 is a plot showing how an illustrative RIS can exhibit beam squinting effects in accordance with some embodiments.

FIG. 9 is a flow chart of illustrative operations involved in performing wireless communications between a transmit device and a receive device while leveraging beam squinting effects to optimize wireless performance in accordance with some embodiments.

FIG. 10 is a plot showing how an illustrative transmit device may vary modulation coding scheme and/or transmit power level across sub-bands of a transmit beam in accordance with some embodiments.

FIG. 11 is a frequency diagram showing how an illustrative transmit device may vary reference signal density across sub-bands of a transmit beam in accordance with some embodiments.

FIG. 12 is a frequency diagram showing how an illustrative transmit device may inform a receive device about the reference signal density of different sub-bands of a transmit beam in accordance with some embodiments.

FIG. 13 is a flow chart of illustrative operations involved in adjusting signal beam width based on beam squinting effects in accordance with some embodiments.

FIG. 14 is a frequency diagram showing how an illustrative transmit device may adjust the frequency domain resource allocation of a transmit beam based on beam squinting effects in accordance with some embodiments.

FIG. 15 is a frequency diagram showing how an illustrative transmit device may perform carrier aggregation band selection based on beam squinting effects in accordance with some embodiments.

FIG. 16 is a flow chart of illustrative operations involved in performing beam selection/management at a transmit device based on beam squinting effects in accordance with some embodiments.

FIG. 17 is a diagram showing how an illustrative transmit device may perform beam selection/management based on beam squinting effects in accordance with some embodiments.

FIG. 18 is a diagram showing how an illustrative receive device may perform beam selection/management based on beam squinting effects in accordance with some embodiments.

FIG. 19 is a diagram showing how an illustrative base station or an illustrative RIS may provide a signal beam at an AOD for communicating with one or more user equipment (UE) devices that move over time in accordance with some embodiments.

FIG. 20 is a flow chart of illustrative operations involved in adjusting a signal beam of a base station or a RIS based on beam squinting effects to maintain communications with a UE device that moves over time in accordance with some embodiments.

FIG. 21 is a frequency diagram showing how an illustrative base station may allocate different frequency resources for the wireless signals conveyed over a signal beam of the base station or a RIS to maintain communications with a UE device that moves over time in accordance with some embodiments.

FIG. 22 is a plot of the variation in array gain of an illustrative base station over different frequencies and azimuth angles showing how adjusting the frequency resources of wireless signals conveyed over a signal beam of the base station may maintain communications with a UE device that moves over time in accordance with some embodiments.

FIG. 23 is a plot of the variation in array gain of an illustrative RIS over different frequencies and azimuth angles showing how adjusting the frequency resources of wireless signals conveyed over a signal beam of the RIS may maintain communications with a UE device that moves over time in accordance with some embodiments.

FIG. 24 is a flow chart of illustrative operations that may be performed by a UE device to predict a change in AOD for a signal beam of a base station or a RIS as the UE device moves over time for use in updating the frequency resources of wireless signals conveyed over the signal beam in accordance with some embodiments.

### DETAILED DESCRIPTION

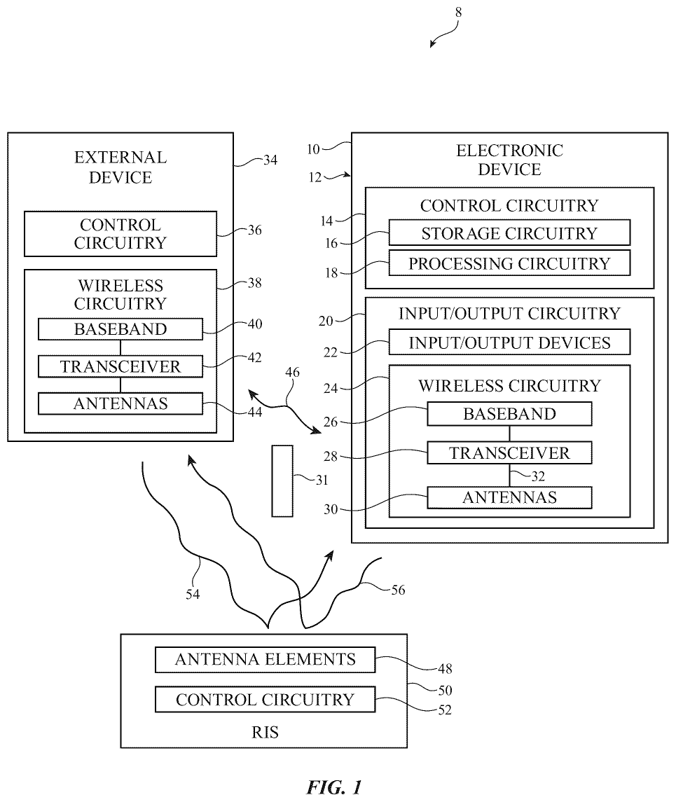

FIG. 1 is a schematic diagram of an illustrative communications system 8 (sometimes referred to herein as communications network 8) for conveying wireless data between communications terminals. Communications system 8 may include network nodes (e.g., communications terminals). The network nodes may include one or more electronic devices such as device 10. The network nodes may also include external communications equipment (e.g., communications equipment other than device 10) such as one or more external devices 34.

Device 10 may be a user equipment (UE) device, a wireless base station, a wireless access point, or other wireless equipment. When implemented as a UE device, device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head (e.g., a head-mounted display device such as virtual, augmented, or mixed reality goggles or glasses), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment.

External device 34 may be a UE device, a wireless base station, a wireless access point, or other wireless equipment. In implementations where external device 34 is a UE device, external device 34 may, if desired, be a peripheral or accessory device (e.g., a user input device, a gaming controller, a stylus, a display device, a head-mounted display, headphones, one or more earbuds, a case, etc.) for device 10 (e.g., a cellular telephone, a wristwatch, a head-mounted display, a desktop computer, a tablet computer, a laptop computer, a gaming console, a device integrated into a vehicle, etc.). These examples are illustrative and, in general, external device 34 and device 10 may include any desired wireless communications equipment or other equipment having wireless communications capabilities. Device 10 and external device 34 may communicate with each other using one or more wireless communications links. If desired, device 10 may wirelessly communicate with external device 34 without passing communications through any other intervening network nodes in communications system 8 (e.g., device 10 may communicate directly with external device 34 over-the-air). Implementations in which external device 34 is a base station (e.g., a gNB) of a cellular communications network are sometimes described herein as an example. The cellular communications network may be operated by a mobile network operator (MNO) and may convey cellular telephone data (e.g., voice and/or data traffic) between UE devices and other network hosts such as other UE devices, a content delivery network, a message or call routing server, an emergency broadcaster, etc. In practice, base stations are generally fixed at a given spatial (geographic) location on Earth. On the other hand, UE devices (e.g., device 10) are generally mobile and move across different spatial locations on Earth over time (e.g., since the users of the UE devices often carry the UE devices with them throughout the day).

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), device-to-device (D2D) protocols, peer-to-peer (P2P) protocols, antenna-based spatial ranging protocols, optical communications protocols, ultra-low latency audio protocols, spatial audio protocols, spatial video protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include baseband circuitry such as baseband circuitry 26 (e.g., one or more baseband processors and/or other circuitry that operates at baseband), radio-frequency (RF) transceiver circuitry such as transceiver 28, and one or more antennas 30. If desired, wireless circuitry 24 may include multiple antennas 30 that are arranged into a phased antenna array (sometimes referred to as a phased array antenna) that conveys radio-frequency signals within a corresponding signal beam that can be steered in different directions. Baseband circuitry 26 may be coupled to transceiver 28 over one or more baseband data paths. Transceiver 28 may be coupled to antennas 30 over one or more radio-frequency transmission line paths 32. If desired, radio-frequency front end circuitry may be disposed on radio-frequency transmission line path(s) 32 between transceiver 28 and antennas 30.

In the example of FIG. 1, wireless circuitry 24 is illustrated as including only a single transceiver 28 and a single radio-frequency transmission line path 32 for the sake of clarity. In general, wireless circuitry 24 may include any desired number of transceivers 28, any desired number of radio-frequency transmission line paths 32, and any desired number of antennas 30. Each transceiver 28 may be coupled to one or more antennas 30 over respective radio-frequency transmission line paths 32. Radio-frequency transmission line path 32 may be coupled to antenna feeds on one or more antenna 30. Each antenna feed may, for example, include a positive antenna feed terminal and a ground antenna feed terminal. Radio-frequency transmission line path 32 may have a positive transmission line signal path that is coupled to the positive antenna feed terminal and may have a ground transmission line signal path that is coupled to the ground antenna feed terminal. This example is merely illustrative and, in general, antennas 30 may be fed using any desired antenna feeding scheme.

Radio-frequency transmission line path 32 may include transmission lines that are used to route radio-frequency antenna signals within device 10. Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 32 may be integrated into rigid and/or flexible printed circuit boards. In one embodiment, radio-frequency transmission line paths such as radio-frequency transmission line path 32 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

In performing wireless transmission, baseband circuitry 26 may provide baseband signals to transceiver 28 (e.g., baseband signals that include wireless data for transmission). Transceiver 28 may include circuitry for converting the baseband signals received from baseband circuitry 26 into corresponding radio-frequency signals (e.g., for modulating the wireless data onto one or more carriers for transmission, synthesizing a transmit signal, etc.). For example, transceiver 28 may include mixer circuitry for up-converting the baseband signals to radio frequencies prior to transmission over antennas 30. Transceiver 28 may also include digital to analog converter (DAC) and/or analog to digital converter (ADC) circuitry for converting signals between digital and analog domains. Transceiver 28 may transmit the radio-frequency signals over antennas 30 via radio-frequency transmission line path 32. Antennas 30 may transmit the radio-frequency signals to external wireless equipment by radiating the radio-frequency signals into free space.

In performing wireless reception, antennas 30 may receive radio-frequency signals from external device 34. The received radio-frequency signals may be conveyed to transceiver 28 via radio-frequency transmission line path 32. Transceiver 28 may include circuitry for converting the received radio-frequency signals into corresponding baseband signals. For example, transceiver 28 may include mixer circuitry for down-converting the received radio-frequency signals to baseband frequencies prior to conveying the baseband signals to baseband circuitry 26 and may include demodulation circuitry for demodulating wireless data from the received signals.

Front end circuitry disposed on radio-frequency transmission line path 32 may include radio-frequency front end components that operate on radio-frequency signals conveyed over radio-frequency transmission line path 32. If desired, the radio-frequency front end components may be formed within one or more radio-frequency front end modules (FEMs). Each FEM may include a common substrate such as a printed circuit board substrate for each of the radio-frequency front end components in the FEM. The radio-frequency front end components in the front end circuitry may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, etc.), impedance matching circuitry (e.g., circuitry that helps to match the impedance of antennas 30 to the impedance of radio-frequency transmission line path 32), antenna tuning circuitry (e.g., networks of capacitors, resistors, inductors, and/or switches that adjust the frequency response of antennas 30), radio-frequency amplifier circuitry (e.g., power amplifier circuitry and/or low-noise amplifier circuitry), radio-frequency coupler circuitry, charge pump circuitry, power management circuitry, digital control and interface circuitry, and/or any other desired circuitry that operates on the radio-frequency signals transmitted and/or received by antennas 30.

While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, baseband circuitry 26 and/or portions of transceiver 28 (e.g., a host processor on transceiver 28) may form a part of control circuitry 14. Baseband circuitry 26 may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 28 may use antenna(s) 30 to transmit and/or receive wireless signals that convey wireless communications data between device 10 and external device 34. The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless (radio-frequency) sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc. The sensing operations may, for example, involve the transmission of sensing signals (e.g., radar waveforms), the receipt of corresponding reflected signals (e.g., the transmitted waveforms that have reflected off of external objects), and the processing of the transmitted signals and the received reflected signals (e.g., using a radar scheme).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, 6G bands at sub-THz or THz frequencies greater than about 100 GHz, etc.), other centimeter or millimeter wave frequency bands between 10-100 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), D2D bands, ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-100 Gbps or higher, wireless circuitry 24 may convey wireless signals at frequencies greater than about 100 GHz.

As shown in FIG. 1, wireless circuitry 24 may transmit wireless signals 46 to external device 34 and/or may receive wireless signals 46 from external device 34. Wireless signals 46 may be tremendously high frequency (THF) signals (e.g., sub-THz or THz signals) at frequencies greater than or equal to around 100 GHz (e.g., between 100 GHz and 1 THz, between 80 GHz and 10 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHz, between 200 GHz and 1.5 THz, or within any desired sub-THz, THz, THF, or sub-millimeter frequency band such as a 6G frequency band), may be millimeter (mm) or centimeter (cm) wave signals between 10 GHz and around 70 GHz (e.g., 5G NR FR2 signals), or may be signals at frequencies less than 10 GHz (e.g., 5G NR FR1 signals, LTE signals, 3G signals, 2G signals, WLAN signals, Bluetooth signals, UWB signals, etc.). When transmitting wireless signals 46, device 10 is sometimes also referred to herein as a transmitter device or a transmit (TX) device. When receiving wireless signals 46, device 10 is sometimes referred to herein as a receiver device or a receive (RX) device.

If desired, the high data rates supported by THE signals may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate video link between a display driver on device 10 and a display that displays ultra-high resolution video, to form a high data rate video link between a display driver on another device and a display on device 10 that displays ultra-high resolution video, to form a high data rate audio link between an audio driver on device 10 and wireless headphones or earbuds that output high fidelity spatial audio, to form a high data rate audio link between an audio driver on another device and speakers on device 10, etc.), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

In implementations where wireless circuitry 24 conveys THF signals, the wireless circuitry may include electro-optical circuitry if desired. The electro-optical circuitry may include light sources that generate first and second optical local oscillator (LO) signals. The first and second optical LO signals may be separated in frequency by the intended frequency of wireless signals 46. Wireless data may be modulated onto the first optical LO signal and one of the optical LO signals may be provided with an optical phase shift (e.g., to perform beamforming). The first and second optical LO signals may illuminate a photodiode that produces current at the frequency of wireless signals 46 when illuminated by the first and second optical LO signals. An antenna resonating element of a corresponding antenna 30 may convey the current produced by the photodiode and may radiate corresponding wireless signals 46. This is merely illustrative and, in general, wireless circuitry 24 may generate wireless signals 46 using any desired techniques.

Antennas 30 may be formed using any desired antenna structures. For example, antennas 30 may include antennas with resonating elements that are formed from loop antenna structures, patch antenna structures, inverted-F antenna structures, slot antenna structures, planar inverted-F antenna structures, helical antenna structures, monopole antennas, dipoles (e.g., planar dipole antennas such as bowtie antennas), hybrids of these designs, etc. Parasitic elements may be included in antennas 30 to adjust antenna performance.

If desired, two or more of antennas 30 may be integrated into a phased antenna array (sometimes referred to herein as a phased array antenna or an array of antenna elements). Each antenna 30 in the phased antenna array forms a respective antenna element of the phased antenna array. Each antenna 30 in the phased antenna array has a respective phase and magnitude controller that imparts the radio-frequency signals conveyed by that antenna with a respective phase and magnitude. The respective phases and magnitudes may be selected (e.g., by control circuitry 14) to configure the radio-frequency signals conveyed by the antennas 30 in the phased antenna array to constructively and destructively interfere in such a way that the radio-frequency signals collectively form a signal beam (e.g., a signal beam of wireless signals 46) oriented in a corresponding beam pointing direction (e.g., a direction of peak gain).

The control circuitry may adjust the phases and magnitudes to change (steer) the orientation of the signal beam (e.g., the beam pointing direction) to point in other directions over time. This process may sometimes also be referred to herein as beamforming. Beamforming may boost the gain of wireless signals 46 to help overcome over-the-air attenuation and the signal beam may be steered over time to point towards external device 34 even as the position and orientation of device 10 changes. The signal beams formed by antennas 30 of device 10 may sometimes be referred to herein as device beams, UE beams, or device signal beams. Each UE beam may be oriented in a different respective direction (e.g., a beam pointing direction of peak signal gain) as defined by corresponding phase and/or magnitude settings of the phase antenna array. Each UE beam may be labeled by a corresponding UE beam index. Device 10 may include or store a codebook that maps each of its UE beam indices to the corresponding phase and magnitude settings for each antenna 30 in a phased antenna array that configure the phased antenna array to form the UE beam associated with that UE beam index.

As shown in FIG. 1, external device 34 may also include control circuitry 36 (e.g., control circuitry having similar components and/or functionality as control circuitry 14 in device 10) and wireless circuitry 38 (e.g., wireless circuitry having similar components and/or functionality as wireless circuitry 24 in device 10). If desired, external device 34 may include input/output devices (not shown in FIG. 1 for the sake of clarity) such as input/output devices 22 of device 10. Wireless circuitry 38 may include baseband circuitry 40 and transceiver 42 (e.g., transceiver circuitry having similar components and/or functionality as transceiver circuitry 28 in device 10) coupled to two or more antennas 44 (e.g., antennas having similar components and/or functionality as antennas 30 in device 10). Antennas 44 may be arranged in one or more phased antenna arrays (e.g., phased antenna arrays that perform beamforming similar to phased antenna arrays of antennas 30 on device 10).

External device 34 may use wireless circuitry 38 to transmit a signal beam of wireless signals 46 to device 10 and/or to receive a signal beam of wireless signals 46 transmitted by device 10. The signal beams formed by antennas 44 of external device 34 may sometimes be referred to herein as external device beams, external device signal beams, or BS beams (e.g., in implementations where external device 34 is a wireless base station (BS)). Each BS beam may be oriented in a different respective direction (e.g., a beam pointing direction of peak signal gain) as defined by the corresponding phase and magnitude settings of the phased antenna array. Each BS beam may be labeled by a corresponding external device beam index. External device 34 may include or store a codebook that maps each of its BS beam indices to the corresponding phase and magnitude settings for each antenna 44 in a phased antenna array that configure the phased antenna array to form the BS beam associated with that BS beam index.

While communications at high frequencies allow for extremely high data rates (e.g., greater than 100 Gbps), wireless signals 46 at such high frequencies are subject to significant attenuation during propagation over-the-air. Integrating antennas 30 and 44 into phased antenna arrays helps to counteract this attenuation by boosting the gain of the signals within a signal beam. However, signal beams are highly directive and may require a line-of-sight (LOS) between device 10 and external device 34. If an external object is present between external device 34 and device 10, the external object may block the LOS between device 10 and external device 34, which can disrupt wireless communications using wireless signals 46. If desired, a reflective device such as a reconfigurable intelligent surface (RIS) may be used to allow device 10 and external device 34 to continue to communicate using wireless signals 46 even when an external object blocks the LOS between device 10 and external device 34 (or whenever direct over-the-air communications between external device 34 and device 10 otherwise exhibits less than optimal performance).

As shown in FIG. 1, system 8 may include one or more reconfigurable intelligent surfaces (RIS's) such as RIS 50. RIS 50 may sometimes also be referred to as an intelligent reconfigurable surface, an intelligent reflective/reflecting surface, a reflective intelligent surface, a reflective surface, a reflective device, a reconfigurable reflective device, a reconfigurable reflective surface, or a reconfigurable surface. External device 34 may be separated from device 10 by a line-of-sight (LOS) path. In some circumstances, an external object such as object 31 may block the LOS path. Object 31 may be, for example, part of a building such as a wall, window, floor, or ceiling (e.g., when device 10 is located inside), furniture, a body or body part, an animal, a cubicle wall, a vehicle, a landscape feature, or other obstacles or objects that may block the LOS path between external device 34 and device 10.

In the absence of external object 31, external device 34 may form a corresponding BS beam of wireless signals 46 oriented in the direction of device 10 and device 10 may form a corresponding UE beam of wireless signals 46 oriented in the direction of external device 34. Device 10 and external device 34 can then convey wireless signals 46 over their respective signal beams and the LOS path. However, the presence of external object 31 prevents wireless signals 46 from being conveyed over the LOS path.

RIS 50 may be placed or disposed within system 8 so as to allow RIS 50 to redirect (e.g., reflect and/or transmit) wireless signals 46 between device 10 and external device 34 despite the presence of external object 31 within the LOS path. More generally, RIS 50 may be used to reflect wireless signals 46 between device 10 and external device 34 when reflection via RIS 50 offers superior radio-frequency propagation conditions relative to the LOS path regardless of the presence of external object 31 (e.g., when the LOS path between external device 34 and RIS 50 and the LOS path between RIS 50 and device 10 exhibit superior propagation/channel conditions than the direct LOS path between device 10 and external device 34). While RIS 50 may additionally or alternatively redirect wireless signals 46 in different directions via transmission through RIS 50 (e.g., by imparting different phases to incident wireless signals 46 that are redirected, via passive transmission, by RIS 50 within the hemisphere opposite to that which the RIS received the signals, as if the RIS were transparent to the signals), implementations in which RIS 50 reflects wireless signals 46 between device 10 and external device 34 are illustrated and described herein as an example for the sake of simplicity and conciseness.

When RIS 50 is placed within system 8, external device 34 may transmit wireless signals 46 towards RIS 50 (e.g., within a BS beam oriented towards RIS 50 rather than towards device 10) and RIS 50 may reflect the wireless signals towards device 10, as shown by arrow 54. Conversely, device 10 may transmit wireless signals 46 towards RIS 50 (e.g., within a UE beam oriented towards RIS 50 rather than towards external device 34) and RIS 50 may reflect the wireless signals towards external device 34, as shown by arrow 56.

RIS 50 is an electronic device that includes a one or two-dimensional surface of engineered material having reconfigurable properties for performing (e.g., reflecting) communications between external device 34 and device 10. RIS 50 may include an array of reflective elements such as antenna elements 48 on an underlying substrate. Antenna elements 48 may also sometimes be referred to herein as reflective elements 48, reconfigurable antenna elements 48, reconfigurable reflective elements 48, reflectors 48, or reconfigurable reflectors 48. Antenna elements 48 may be arranged in a one-dimensional array or a two-dimensional array. When implemented in a one-dimensional array, antenna elements 48 may be arranged linearly (e.g., as Uniform Linear Array (ULA)), circularly (e.g., as a circular array), or along a linear manifold. When implemented in a two-dimensional array (e.g., as a Uniform Planar Array (UPA)), antenna elements 48 may be arranged in a plane, in a curved surface (e.g., on a dome to obtain more omni-directional coverage), or in any two-dimensional manifold. If desired, antenna elements 48 may even be arranged three dimensionally (e.g., on the vertices of a 3D lattice structure). Similarly, device 10 may include a phased antenna array of antennas 30 arranged in a one-dimensional array (e.g., as a ULA), in a two-dimensional array (e.g., as a UPA), in a three-dimensional array or in any other desired pattern. Likewise, external device 34 may include a phased array of antennas 44 arranged in a one-dimensional array (e.g., as a ULA), in a two-dimensional array (e.g., as a UPA), in a three-dimensional array or in any other desired pattern.

The substrate of RIS 50 may be a rigid or flexible printed circuit board, a package, a plastic substrate, meta-material, a semiconductor (e.g., silicon) substrate, a ceramic substrate, or any other desired substrate. The substrate may be planar or may be curved in one or more dimensions. If desired, the substrate and antenna elements 48 may be enclosed within a housing. The housing may be formed from materials that are transparent to wireless signals 46. If desired, RIS 50 may be disposed (e.g., layered) on an underlying electronic device. RIS 50 may also be provided with mounting structures (e.g., adhesive, brackets, a frame, screws, pins, clips, etc.) that can be used to affix or attach RIS 50 to an underlying structure such as another electronic device, a wall, the ceiling, the floor, furniture, etc. Disposing RIS 50 on a ceiling, wall, window, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing RIS 50 to reflect wireless signals between external device 34 and device 10 around various objects 31 that may be present (e.g., when external device 34 is located outside and device 10 is located inside, when external device 34 and device 10 are both located inside or outside, etc.).

RIS 50 may be a passive adaptively controlled reflecting surface and a powered device that includes control circuitry 52 that helps to control the operation of antenna elements 48 (e.g., one or more processors in control circuitry such as control circuitry 14). When electro-magnetic (EM) energy waves (e.g., waves of wireless signals 46) are incident on RIS 50, the wave is reflected by each antenna element 48 via re-radiation by each antenna element 48 with a respective phase and amplitude response. Antenna elements 48 may include passive reflectors (e.g., antenna resonating elements or other radio-frequency reflective elements). In implementations where RIS 50 is transmissive, antenna elements 48 may include passive elements that redirect signals in a transmissive mode. Each antenna element 48 may include an adjustable device that is programmed, set, and/or controlled by control circuitry 52 (e.g., using a control signal that includes or represents a respective beamforming coefficient) to configure that antenna element 48 to reflect incident EM energy with the respective phase and amplitude response (e.g., with a respective reflection coefficient). The adjustable device may be a programmable photodiode, an adjustable impedance matching circuit, an adjustable phase shifter, an adjustable amplifier, a varactor diode, an antenna tuning circuit, combinations of these, etc. Alternatively, RIS 50 may be implemented as a reconfigurable holographic surface (RHS) in which the adjustable devices are omitted.

Control circuitry 52 on RIS 50 may configure the reflective response of antenna elements 48 on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). The scattering, absorption, reflection, transmission, and diffraction properties of the entire RIS can therefore be changed over time and controlled (e.g., by software running on the RIS or other devices communicably coupled to the RIS such as external device 34 or device 10).

One way of achieving the per-element phase and amplitude response of antenna elements 48 is by adjusting the impedance of antenna elements 48, thereby controlling the complex reflection coefficient that determines the change in amplitude and phase of the re-radiated signal. The control circuitry 52 on RIS 50 may configure antenna elements 48 to exhibit impedances that serve to reflect wireless signals 46 incident from particular incident angles onto particular output angles. The antenna elements 48 (e.g., the antenna impedances) may be adjusted to change the angle with which incident wireless signals 46 are reflected off of RIS 50.

For example, the control circuitry on RIS 50 may configure antenna elements 48 to reflect wireless signals 46 transmitted by external device 34 towards device 10 (as shown by arrow 54) and to reflect wireless signals 46 transmitted by device 10 towards external device 34 (as shown by arrow 56). In such an example, control circuitry 36 may configure (e.g., program) a phased antenna array of antennas 44 on external device 34 to form a BS beam oriented towards RIS 50, control circuitry 14 may configure (e.g., program) a phased antenna array of antennas 30 on device 10 to form a UE beam oriented towards RIS 50, control circuitry 52 may configure (e.g., program) antenna elements 48 to receive and re-radiate (e.g., effectively redirect via reflection or, alternatively, transmission) the wireless signals incident from the direction of external device 34 towards/onto the direction of device 10 (as shown by arrow 54), and control circuitry 52 may configure (e.g., program) antenna elements 48 to receive and re-radiate (e.g., effectively redirect via reflection or, alternatively, transmission) the wireless signals incident from the direction of device 10 towards/onto the direction of external device 34 (as shown by arrow 56). The antenna elements may be configured using respective beamforming coefficients. Control circuitry 52 on RIS 50 may set and adjust the adjustable devices coupled to antenna elements 48 (e.g., may set and adjust the impedances of antenna elements 48) over time to reflect wireless signals 46 incident from different selected incident angles onto different selected output angles.

To minimize the cost, complexity, and power consumption of RIS 50, RIS 50 may include only the components and control circuitry required to control and operate antenna elements 48 to reflect wireless signals 46. Such components and control circuitry may include, for example, the adjustable devices of antenna elements 48 as required to change the phase and magnitude responses of antenna elements 48 (based on corresponding beamforming coefficients) and thus the direction with which RIS 50 reflects wireless signals 46. The components may include, for example, components that adjust the impedances of antenna elements 48 so that each antenna element exhibits a respective complex reflection coefficient, which determines the phase and amplitude of the reflected (re-radiated) signal produced by each antenna element (e.g., such that the signals reflected across the array constructively and destructively interfere to form a reflected signal beam in a corresponding beam pointing direction).

All other components that would otherwise be present in device 10 or external device 34 may be omitted from RIS 50. For example, RIS 50 may be free from baseband circuitry (e.g., baseband circuitry 26 or 40) and/or transceiver circuitry (e.g., transceiver 42 or 28) coupled to antenna elements 48. Antenna elements 48 and RIS 50 may therefore be incapable of generating wireless data for transmission, synthesizing radio-frequency signals for transmission, and/or receiving and demodulating incident radio-frequency signals. RIS 50 may also be implemented without a display or user input device. In other words, the control circuitry on RIS 50 may adjust antenna elements 48 to direct and steer reflected wireless signals 46 without using antenna elements 48 to perform any data transmission or reception operations and without using antenna elements 48 to perform radio-frequency sensing operations. In other implementations, the RIS may include some active circuitry such as circuitry for demodulating received signals using the data RAT (e.g., to perform channel estimates for optimizing its reflection coefficients).

This may serve to minimize the hardware cost and power consumption of RIS 50. If desired, RIS 50 may also include one or more antennas (e.g., antennas separate from the antenna elements 48 used to reflect wireless signals 46) and corresponding transceiver/baseband circuitry that uses the one or more antennas to convey control signals with external device 34 or device 10 (e.g., using a control channel plane and control RAT). Such control signals may be used to coordinate the operation of RIS 50 in conjunction with external device 34 and/or device 10 but requires much lower data rates and thus much fewer processing resources and much less power than transmitting or receiving wireless signals 46. These control signals may, for example, be transmitted by device 10 and/or external device 34 to configure the phase and magnitude responses of antenna elements 48 (e.g., the control signals may convey beamforming coefficients). This may allow the calculation of phase and magnitude responses for antenna elements 48 to be offloaded from RIS 50, further reducing the processing resources and power required by RIS 50. In other implementations, RIS 50 may be a self-controlled RIS that includes processing circuitry for generating its own phase and magnitude responses and/or for coordinating communications among multiple devices (e.g., in a RIS-as-a-service configuration).

In this way, RIS 50 may help to relay wireless signals 46 between external device 34 and device 10 when object 31 blocks the LOS path between external device 34 and device 10 and/or when the propagation conditions from external device 34 to RIS 50 and from RIS 50 to device 10 are otherwise superior to the propagation conditions from external device 34 to device 10. Just a single RIS 50 may, for example, increase signal-to-interference-plus-noise ratio (SINR) for device 10 by as much as +20 dB and may increase effective channel rank relative to environments without an RIS. At the same time, RIS 50 may include only the processing resources and may consume only the power required to perform control procedures, minimizing the cost of RIS 50 and maximizing the flexibility with which RIS 50 can be placed within the environment.

RIS 50 may include or store a codebook (sometimes referred to herein as a RIS codebook) that maps settings for antenna elements 48 to different reflected (or transmitted) signal beams formable by antenna elements 48 (sometimes referred to herein as RIS beams). RIS 50 may configure its own antenna elements 48 to perform beamforming with respective beamforming coefficients (e.g., as given by the RIS codebook). The beamforming performed at RIS 50 may include two concurrently active RIS beams (e.g., where each RIS beam is generated using a corresponding set of beamforming coefficients) or equivalently, a single reflected beam having an incident and output angle relative to a lateral surface of the RIS. While referred to herein as “beams,” the RIS beams formed by RIS 50 do not include signals/data that are actively transmitted by RIS 50 but instead correspond to the impedance, phase, and/or magnitude response settings (e.g., reflection coefficients) for antenna elements 48 that shape the reflected signal beam of wireless signals 46 from a corresponding incident direction/angle onto a corresponding output direction/angle (e.g., one RIS beam may be effectively formed using a first set of beamforming coefficients whereas another RIS beam may be effectively formed using a second set of beamforming coefficients).

In general, RIS 50 may relay signals between two different devices or may reflect signals transmitted by a single device back to that device. RIS 50 may form a first active RIS beam that has a beam pointing direction oriented towards a first device such as external device 34 (sometimes referred to here as a RIS-BS beam when external device 34 is a BS) and may concurrently form a second active RIS beam that has a beam pointing direction oriented towards a second device such as device 10 (sometimes referred to herein as a RIS-UE beam when device 10 is a UE device). In this way, when wireless signals 46 are incident from the first device (e.g., external device 34) within the first RIS beam, the antenna elements 48 on RIS 50 may receive the wireless signals incident from the direction the first device (e.g., external device 34) and may re-radiate (e.g., effectively reflect) the incident wireless signals within the second RIS beam and towards the direction of the second device (e.g., device 10). Conversely, when wireless signals 46 are incident from the second device (e.g., device 10) within the second RIS beam, the antenna elements 48 on RIS 50 may receive the wireless signals incident from the direction the second device (e.g., device 10) and may re-radiate (e.g., effectively reflect) the incident wireless signals within the first RIS beam and towards the direction of the first device (e.g., external device 34). If desired, the first and second RIS beams may be oriented in the same direction to reflect incident signals back in the direction the signals were received from.

The example of FIG. 1 is illustrative and non-limiting. If desired, RIS 50 may be omitted from communications system 8. If desired, communications system 8 may include multiple RIS's 50. If desired, a chain or series of multiple RIS's 50 at different locations may be used to relay wireless signals 46 between external device 34 and device 10 (e.g., using a sequence of reflections or hops between the RIS's). If desired, communications system 8 may include multiple devices 10 (e.g., UE devices) that convey wireless signals 46 with external device 34 (e.g., a BS) directly and/or via one or more RIS's 50. If desired, communications system 8 may include multiple external devices 34 (e.g., base stations) disposed at different locations (e.g., within respective cells of a cellular telephone network). While sometimes referred to herein as a base station, the base station may equivalently form a wireless access point (e.g., of a wireless local area network having any desired number of access points distributed across different locations).

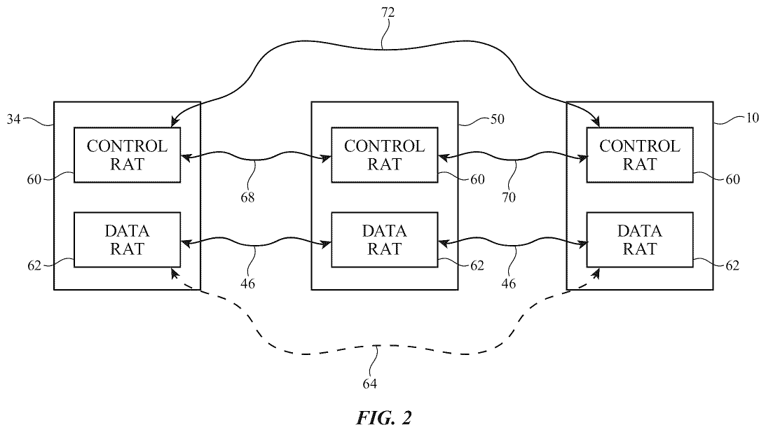

FIG. 2 is a diagram showing how external device 34, RIS 50, and device 10 may communicate using both a control RAT and a data transfer RAT for establishing and maintaining communications between external device 34 and device 10 via RIS 50. As shown in FIG. 2, external device 34, RIS 50, and device 10 may each include wireless circuitry that operates according to a data transfer RAT 62 (sometimes referred to herein as data RAT 62) and a control RAT 60. Data RAT 62 may be a sub-THz communications RAT such as a 6G RAT that performs wireless communications at the frequencies of wireless signals 46. Control RAT 60 may be associated with wireless communications that consume much fewer resources and are less expensive to implement than the communications of data RAT 62. For example, control RAT 60 may be Wi-Fi, Bluetooth, a cellular telephone RAT such as a 3G, 4G, or 5G NR FR1 RAT, etc. As another example control RAT 60 may be an infrared communications RAT (e.g., where an infrared remote control or infrared emitters and sensors use infrared light to convey signals for the control RAT between device 10, external device 34, and/or RIS 50).

External device 34 and RIS 50 may use control RAT 60 to convey radio-frequency signals 68 (e.g., control signals) between external device 34 and RIS 50. Device 10 and RIS 50 may use control RAT 60 to convey radio-frequency signals 70 (e.g., control signals) between device 10 and RIS 50. Device 10, external device 34, and RIS 50 may use data RAT 62 to convey wireless signals 46 via reflection off antenna elements 48 of RIS 50. The wireless signals may be reflected (or transmitted), via the first RIS beam and the second RIS beam formed by RIS 50, between external device 34 and device 10. External device 34 may use radio-frequency signals 68 and control RAT 60 and/or device 10 may use radio-frequency signals 70 and control RAT 60 to discover RIS 50 and to configure antenna elements 48 to establish and maintain the relay of wireless signals 46 performed by antenna elements 48 using data RAT 62.

If desired, external device 34 and device 10 may also use control RAT 60 to convey radio-frequency signals 72 directly with each other (e.g., since the control RAT operates at lower frequencies that do not require line-of-sight). Device 10 and external device 34 may use radio-frequency signals 72 to help establish and maintain THF communications (communications using data RAT 62) between device 10 and external device 34 via RIS 50. External device 34 and device 10 may also use data RAT 62 to convey wireless signals 46 directly (e.g., without reflection off RIS 50) when a LOS path is available (as shown by path 64).

If desired, the same control RAT 60 may be used to convey radio-frequency signals 68 between external device 34 and RIS 50 and to convey radio-frequency signals 70 between RIS 50 and device 10. If desired, external device 34, RIS 50, and/or device 10 may support multiple control RATs 60. In these scenarios, a first control RAT 60 (e.g., Bluetooth) may be used to convey radio-frequency signals 68 between external device 34 and RIS 50, a second control RAT 60 (e.g., Wi-Fi) may be used to convey radio-frequency signals 70 between RIS 50 and device 10, and/or a third control RAT 60 may be used to convey radio-frequency signals 72 between external device 34 and device 10. Processing procedures (e.g., work responsibilities) may be divided between data RAT 62 one or more control RAT 60 during discovery, initial configuration, data RAT communication between device 10 and external device 34 via RIS 50, and beam tracking of device 10.

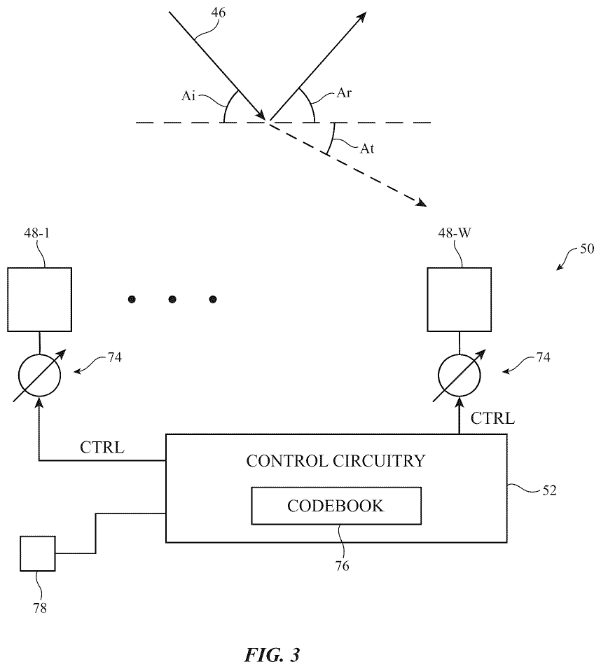

FIG. 3 is a diagram of RIS 50. As shown in FIG. 3, RIS 50 may include a set of W antenna elements 48 (e.g., a first antenna element 48-1, a Wth antenna element 48-W, etc.). Antenna elements 48 may include patches, monopoles, dipoles, inverted-F elements, planar inverted-F elements, slots, or other structures formed from metal or metamaterials/metastructures on an underlying substrate. The W antenna elements 48 may be arranged in an array pattern. The antenna elements 48 on RIS 50 may have sub-wavelength spacing and may each have a sub-wavelength width/size. The array pattern may have rows and columns. Other array patterns may be used if desired. Each antenna element 48 may be coupled to a corresponding adjustable device 74. Adjustable devices 74 may include, as one example, a diode switch. Each adjustable device 74 and its corresponding antenna element 48 may sometimes be referred to herein as a unit cell of RIS 50 (e.g., RIS 50 may have W unit cells).

Control circuitry 52 may provide respective control signals CTRL (e.g., variable voltages) to adjustable devices 74 that configure each adjustable device 74 to impart a selected impedance to its corresponding antenna element 48. The impedance may effectively impart a corresponding phase shift to incident THF signals that are scattered (e.g., re-radiated or effectively reflected) by the antenna element. Adjustable devices 74 may therefore sometimes be referred to herein as phase shifters 74.

Control circuitry 52 may transmit control signals CTRL to adjustable devices 74 to control each adjustable device 74 to exhibit a corresponding phase setting and thus a corresponding reflection coefficient (beamforming coefficient). The control signal CTRL provided to each adjustable device 74 may identify, contain, carry, or otherwise represent the corresponding phase setting, reflection coefficient, or beamforming coefficient. Each phase setting (beamforming coefficient) may cause the corresponding antenna element 48 to impart a particular phase shift to the wireless signals 46 scattered (reflected) by the antenna element for data RAT 62. Put differently, each phase setting may configure the corresponding antenna element 48 to exhibit a particular reflection coefficient or impedance for incident THF signals.

By selecting the appropriate settings (phase shift settings, applied phase shifts, or beamforming coefficients) for adjustable devices 74, the array of antenna elements 48 may be configured to collectively form RIS beams in different directions (e.g., to reflect/scatter wireless signals 46 incident from incident angles associated with a first RIS beam onto corresponding output angles associated with a second RIS beam). For example, the array of antenna elements 48 may be configured to redirect wireless signals incident from an angle-of-arrival (AOA) Ai (e.g., within the first RIS beam oriented in the direction of AOA Ai) onto a corresponding angle-of-departure (AOD) (e.g., a second RIS beam oriented in the direction of AOD Ar when RIS 50 reflects wireless signals 46 or oriented in the direction of AOD At when RIS 50 transmits wireless signals 46). The AOA Ai of RIS 50 is sometimes also referred to herein as RIS AOA Ai. The AOD Ar (or At) of RIS 50 is sometimes also referred to herein as RIS AOD Ar (or At).

As shown in FIG. 3, RIS 50 may have one or more antennas 78. Antenna(s) 78 may include one or more of the W antenna elements 48 or may be separate from the W antenna elements 48 on RIS 50. Antenna(s) 78 may be coupled to a control RAT transceiver on RIS 50 and may be used to convey control signals over control RAT 60. Control circuitry 52 may transmit control signals using antenna(s) 78 and/or may receive control signals using antenna(s) 78.

Control circuitry 52 may store a codebook 76 that maps different sets of settings (e.g., phase settings) for adjustable devices 74 to different input/output angles (e.g., to different combinations of first and second RIS beams for RIS 50). Codebook 76 may be populated during manufacture, deployment, calibration, and/or regular operation of RIS 50. Codebook 76 may be stored on storage circuitry or memory on RIS 50. If desired, external device 34, device 10, or a dedicated controller may use control RAT 60 to populate and/or update the entries of codebook 76. During operation, RIS 50 may be controlled to configure (program) adjustable devices 74 to form the RIS beams necessary for RIS 50 to reflect wireless signals 46 between the location of external device 34 and the location of device 10, which may change over time. This may involve selection (calculation) of the appropriate set of phase settings (e.g., imparted phase shifts or reflection coefficients) for adjustable devices 74 to form the RIS beams.

RIS 50 may dynamically change the phase settings (reflection coefficients) of antenna elements 48 over time (e.g., to direct reflected signals in different directions to serve one or more external devices 34 as the position of the external device(s) and/or device 10 changes over time). If desired, RIS 50 may be at least partially controlled by a remote controller located on an external device other than RIS 50. The remote controller may be located on an electronic device such as external device 34, device 10, a dedicated RIS controller, and/or other nodes of system 8 (FIG. 1). The remote controller may be distributed across multiple devices or network nodes if desired.

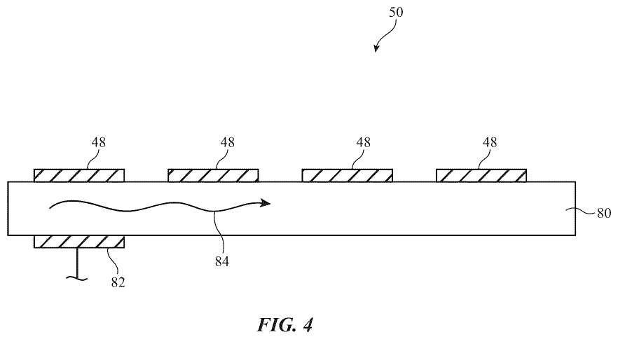

If desired, RIS 50 may be implemented as an RHS. FIG. 4 is a cross-sectional side view showing one example of how RIS 50 may be implemented as an RHS. As shown in FIG. 4, RIS 50 may include a substrate 80 (e.g., a printed circuit board substrate). Antenna elements 48 may be printed or patterned onto a surface of substrate 80 (e.g., as metamaterial elements or patches). The antenna elements are not coupled to adjustable devices 74 (FIG. 3) in this example (e.g., adjustable devices 74 may be omitted from RIS 50 when implemented as an RHS).

RIS 50 may also include one or more feed probes 82 coupled to substrate 80 (e.g., embedded in a bottom layer of substrate 80). Feed probes 82 may generate or excite reference waves 84 that propagate along substrate 80 (e.g., substrate 80 may act as an electromagnetic waveguide for reference waves 84). Reference waves 84 may excite the electromagnetic field of the RHS. The electromagnetic response of antenna elements 48 is intelligently controlled such that the radiation characteristic of reference waves 84 is dictated by the electromagnetic response of each antenna element 48. The antenna elements may perform holographic beam forming based on reference waves 84 and the incident wireless signals 46, which serves to redirect (e.g., diffract) wireless signals 46 incident from RIS AOA Ai (FIG. 3) onto a corresponding RIS AOD (e.g., RIS AOD Ar or At of FIG. 3).

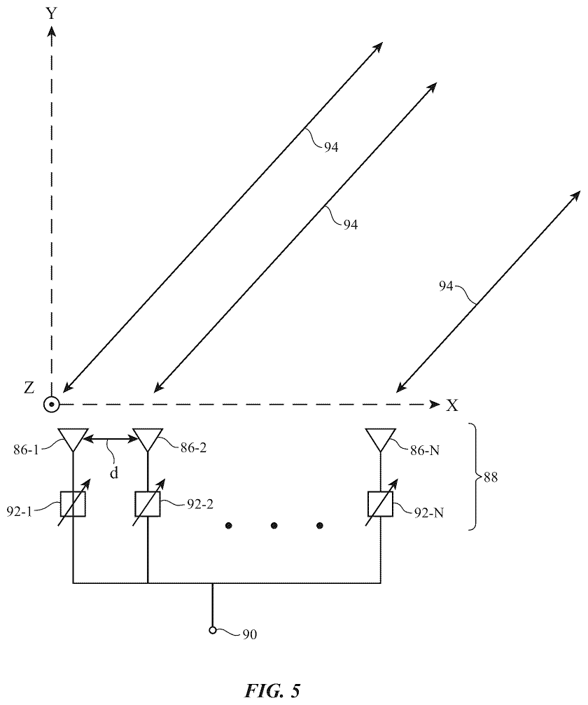

FIG. 5 is a diagram showing how antennas 86 may be arranged in a corresponding phased antenna array 88. Antennas 86 of FIG. 5 may be formed from antennas 30 in device 10 (e.g., phased antenna array 88 may be implemented on device 10 of FIGS. 1 and 2), antennas 44 in external device 34 (e.g., phased antenna array 88 may be implemented in external device 34 of FIGS. 1 and 2), or antenna elements 48 in RIS 50 (e.g., phased antenna array 88 may be implemented in RIS 50 of FIGS. 1, 3, and 4).

As shown in FIG. 5, phased antenna array 88 (sometimes referred to herein as array 88, antenna array 88, or array 88 of antennas 86) may be coupled to respective transmission line paths. For example, a first antenna 86-1 in phased antenna array 88 may be coupled to a first transmission line path, a second antenna 86-2 in phased antenna array 88 may be coupled to a second transmission line path, an Nth antenna 86-N in phased antenna array 88 may be coupled to an Nth transmission line path 32-N, etc. While antennas 86 are described herein as forming a phased antenna array, the antennas 86 in phased antenna array 88 may sometimes also be referred to as collectively forming a single phased array antenna (e.g., where antennas 86 form antenna elements of the phased array antenna).

Antennas 86 in phased antenna array 88 may be arranged in any desired number of rows and columns or in any other desired pattern (e.g., the antennas need not be arranged in a grid pattern having rows and columns). Each antenna 86 may be separated from one or more adjacent antennas 86 in phased antenna array 88 by a predetermined distance d. Distance d may be approximately half the effective wavelength of operation of the array, for example. During signal transmission, the transmission line paths may be used to supply signals (e.g., radio-frequency signals such as millimeter wave, sub-THz, or THz signals) from transceiver circuitry (e.g., via radio-frequency signal port 90) to phased antenna array 88 for wireless transmission. During signal reception, the transmission line paths may be used to supply signals received at phased antenna array 88 (e.g., from external wireless equipment or transmitted signals that have been reflected off of external objects) to transceiver circuitry (e.g., via radio-frequency signal port 90). In implementations where antennas 86 are formed from antenna elements 48 on RIS 50, the antennas do not transmit or receive radio-frequency signals over transmission line paths and instead redirect incident signals from a RIS AOA onto a RIS AOD (e.g., the transmission line paths and radio-frequency signal port 90 of FIG. 5 may be omitted).

The use of multiple antennas 86 in phased antenna array 88 allows beam forming/steering arrangements to be implemented by controlling the relative phases and magnitudes (amplitudes) of the radio-frequency signals conveyed by the antennas. Each transmission line path may therefore have a respective phase and magnitude controller 92 disposed thereon. For example, a first phase and magnitude controller 92-1 may be coupled to antenna 86-1, a second phase and magnitude controller 92-2 may be coupled to antenna 86-2, an Nth phase and magnitude controller 92-N may be coupled to antenna 86-N, etc. Phase and magnitude controllers 92 may include amplifiers (e.g., power amplifiers, low noise amplifiers, and/or bi-directional amplifiers) and/or phase shifters (e.g., radio-frequency phase shifters). In implementations where antennas 86 are formed from antenna elements 48 on RIS 50, phase and magnitude controllers 92 may form adjustable devices 74 of FIG. 3. When RIS 50 is implemented as an RHS, phase and magnitude controllers 92 may be effectively formed via the holographic interaction of reference waves 84 (FIG. 4) with incident wireless signals 46.

Phase and magnitude controllers 92 may adjust the phase and/or magnitude of the radio-frequency signals on the corresponding transmission line paths. The phases and/or magnitudes may be adjusted over time (e.g., based on control signals received from corresponding control circuitry). In implementations where antennas 86 form antenna elements 48 of RIS 50, phase and magnitude controllers 92 may adjust the complex impedance (e.g., reflection coefficients) of antennas 86. The complex impedances may be adjusted over time (e.g., based on control signals received from corresponding control circuitry).

When implemented on external device 34 or device 10 of FIG. 1, phase and magnitude controllers 92 may adjust the relative phases and/or magnitudes of the transmitted signals that are provided to each of the antennas in phased antenna array 88 and may adjust the relative phases and/or magnitudes of the received signals that are received by phased antenna array 88. The term “beam” or “signal beam” may be used herein to collectively refer to radio-frequency (wireless) signals that are transmitted and/or received by phased antenna array 88 in a particular direction. Each beam may exhibit a peak gain that is oriented in a respective beam pointing direction at a corresponding beam pointing angle. Different sets of phase and magnitude settings for phase shifters 42 and amplifiers 38 may configure phased antenna array 88 to form different beams at different beam pointing angles.

When implemented as a planar array, phased antenna array 88 lies in a two dimensional plane such as the X-Z plane. For the sake of simplicity, phased antenna array 88 is illustrated in FIG. 5 as a one-dimensional ULA having a single row of antennas 86 extending along the X-axis and uniformly separated by distance d or, equivalently, FIG. 5 illustrates only a single row of antennas 86 in a two-dimensional UPA extending within the X-Z plane. This is illustrative and, in general, phased antenna array 88 may be a non-uniform two-dimensional array, may be a non-uniform one-dimensional array, may lie in other surfaces or manifolds, may be a three-dimensional array, and/or may have any desired array geometry.

As shown in FIG. 5, phase and magnitude controllers 92 may configure phased antenna array 88 to form a corresponding signal beam 94. Signal beam 94 may be oriented at a corresponding beam pointing angle relative to phased antenna array 88. The beam pointing angle and thus the orientation of the signal beam may be characterized by an elevation angle and an azimuthal angle orthogonal to the elevation angle (e.g., in spherical coordinates). This is illustrative and, in general, any desired coordinate system may be used to characterize the beam pointing angle and thus the orientation of signal beam 94. When wireless signals 46 are incident upon phased antenna array 88 within signal beam 94, signal beam 94 is sometimes also referred to herein as receive (RX) beam 94 and the beam pointing angle is sometimes also referred to herein as the AOA of the wireless signals. When wireless signals 46 are transmitted (or reflected) by phased antenna array 88 within signal beam 94, signal beam 94 is sometimes also referred to herein as transmit (TX) beam 94 and the beam pointing angle is sometimes also referred to herein as the AOD of the wireless signals.

When antennas 86 are formed from antennas 30 on device 10, signal beam 94 is sometimes also referred to herein as a UE beam (e.g., a transmit UE beam or a receive UE beam) oriented at a corresponding UE beam pointing angle (e.g., a UE AOA or a UE AOD). When antennas 86 are formed from antennas 44 on external device 34, signal beam 94 is sometimes also referred to herein as a BS beam (e.g., a transmit BS beam or a receive BS beam) oriented at a corresponding BS beam pointing angle (e.g., a BS AOA or a BS AOD). When antennas 86 are formed from antenna elements 48 on RIS 50, signal beam 94 is sometimes also referred to herein as a RIS beam. The RIS beam 94 may be a receive RIS beam having a corresponding RIS AOA (e.g., when wireless signals 46 are incident upon RIS 50) or may be a reflected RIS beam having a corresponding RIS AOD (e.g., when wireless signals 46 are reflected by RIS 50 towards another device). Each AOA (e.g., the UE AOA, BS AOA, and RIS AOA) may be characterized by a respective elevation angle and a respective azimuthal angle ϕ. Similarly, each AOD (e.g., the UE AOD, BS AOD, and RIS AOD) may be characterized by a respective elevation angle and a respective azimuthal angle ϕ.

When antennas 86 are formed from antennas 30 on device 10 or antennas 44 on external device 34, the phase and/or magnitude of phase and magnitude controllers 92 may be adjusted to change the orientation of signal beam 94 and thus the beam pointing angle over time (e.g., to re-form the beam to point towards another device or to point away from obstacles). If desired, the beam pointing angle may be adjusted over time to maintain a communications link with another device that is moving relative to phased antenna array 88 over time. During signal transmission, the phase and magnitude settings of phase and magnitude controllers 92 cause the wireless signals transmitted by the antennas 86 across phased antenna array 88 to constructively and destructively interfere to form signal beam 94 (e.g., at a corresponding AOD).

During signal reception, the wireless signals received by the antennas 86 across phased antenna array within signal beam 94 are passed to phase and magnitude controllers 92. When configured with the phase and magnitude settings corresponding to signal beam 94 (e.g., the AOA of the signal beam), phase and magnitude controllers 92 cause the received signals to coherently add or combine at radio-frequency signal port 90. When antennas 86 are formed from antenna elements 48 on RIS 50, the complex impedances of phase and magnitude controllers 92 (e.g., adjustable devices 74 of FIG. 3) cause antennas 86 to reflect wireless signals incident from a first RIS beam oriented at a corresponding RIS AOA onto a second RIS beam (e.g., a reflected beam) oriented at a corresponding RIS AOD.

In the example of FIG. 5, beam steering is shown as being performed over a single degree of freedom for the sake of simplicity (e.g., towards the left and right on the page of FIG. 5). However, in practice, the beam may be steered over two or more degrees of freedom (e.g., in three dimensions, into and out of the page and to the left and right on the page of FIG. 5). Phased antenna array 88 may have a corresponding field of view over which beam steering can be performed (e.g., in a hemisphere or a segment of a hemisphere over the phased antenna array).

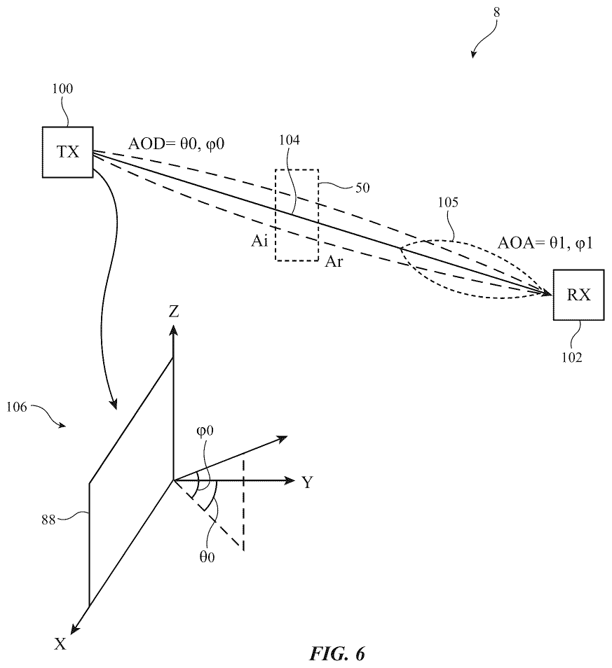

During wireless communications, a transmit (TX) device may transmit wireless signals 46 to a receive (RX) device. FIG. 6 is a diagram showing a TX device 100 that transmits wireless signals 46 to a corresponding RX device 102 in communications system 8. As shown in FIG. 6, TX device 100 may include a phased antenna array 88. As shown by portion 106 of FIG. 6, phased antenna array 88 may lie within a surface such as the X-Z plane (e.g., as a one or two-dimensional array of antennas 86 of FIG. 5).

TX device 100 may transmit wireless signals 46 to RX device 102 over a corresponding TX beam 104 (e.g., a signal beam 94 of the phased antenna array 88 as shown in FIG. 5). RX device 102 may receive wireless signals 46 from TX device 100 over a corresponding RX beam 105 (e.g., a signal beam 94 of a phased antenna array on RX device 102). TX device 100 may any desired device in communications system 8 that transmits wireless signals 46. RX device 102 may be any desired device in communications system 8 that receives wireless signals 46. If desired, TX device 100 may also receive wireless signals 46 (e.g., may be operable as an RX device) and/or RX device 102 may also transmit wireless signals 46 (e.g., may be operable as a TX device). In one implementation that is described herein as an example, TX device 100 is external device 34 of FIG. 1 (e.g., a wireless base station) and RX device 102 is device 10 of FIG. 1 (e.g., a UE device). Alternatively, TX device 100 may be device 10 of FIG. 1 (e.g., a UE device) and RX device 102 may be external device 34 of FIG. 1 (e.g., a wireless base station).

TX beam 104 may be oriented at a corresponding AOD. As shown by portion 106 of FIG. 6, the AOD of TX beam 104 may be characterized or defined by an elevation angle θ0 (e.g., relative to the Y-axis normal to phased antenna array 88) and an azimuthal angle ϕ0 (e.g., relative to the X-Y plane). RX beam 105 of RX device 102 may be oriented at a corresponding AOA. The AOA of RX beam 105 may be characterized or defined by an elevation angle θ1 and an azimuthal angle ϕ1. The phase and magnitude controllers 92 (FIG. 5) coupled to phased antenna array 88 may configure the AOD of TX beam 104 to point towards RX device 102. The phase and magnitude controllers of RX device 102 may configure the AOA of RX beam 105 to point towards TX device 100. In this example, TX device 100 transmits wireless signals 46 directly to RX device 102 without reflection off a RIS. TX device 100 transmits the wireless signals over TX beam 104 and RX device 102 receives the wireless signals over RX beam 105.

Alternatively, TX device 100 may transmit wireless signals 46 to RX device 102 via reflection off RIS 50. In these implementations, the phase and magnitude controllers 92 (FIG. 5) coupled to phased antenna array 88 may configure the AOD of TX beam 104 to point towards RIS 50. The phase and magnitude controllers of RX device 102 may configure the AOA of RX beam 105 to point towards RIS 50. The phase controllers on RIS 50 (e.g., adjustable devices 74 of FIG. 3 or reference waves 84 of FIG. 4) may configure RIS 50 to exhibit a RIS AOA Ai in the direction of TX device 100 and a RIS AOD Ar in the direction of RX device 102. The transmission of wireless signals 46 from TX device 100 to RX device 102 is sometimes described herein without regard to reflection off RIS 50 for the sake of simplicity and clarity. However, in general, the transmission of wireless signals 46 from TX device 100 to RX device 102 as described herein may also include a reflection off one or more RIS's 50 between TX device 100 and RX device 102 if desired.

In practice, phased antenna arrays such as phased antenna array 88 can exhibit beam squinting effects when forming the corresponding signal beam 94. If care is not taken, the beam squinting effects can limit the wireless performance of TX device 100 in transmitting wireless signals 46, the wireless performance of RX device 102 in receiving wireless signals 46, and/or the wireless performance of RIS 50 in redirecting (e.g., reflecting) wireless signals 46 between TX device 100 and RX device 102.

To help explain the beam squinting phenomenon, consider a simplest case in which phased antenna array 88 is implemented as a ULA having N antennas 86 with uniform spacing by distance d. In this example, when receiving signals, there is a time delay τ_{N} between receipt of incident signals at the first antenna and the Nth antenna given by N times distance d, times the sine of the elevation angle, divided by the speed of light c. The time delay difference is independent of the frequency f of the signals, but phase depends on frequency f. The phase and magnitude controllers are set to provide phase shifts that cause the received signals to coherently combine at radio-frequency signal port 90 (e.g., receive beam forming). For this purpose, the phase shifter of the Nth antenna is set to 2πf_{c}τ_{N}, where f_{c} is the carrier frequency of the signals. This functions well for a narrowband signal having a relatively small bandwidth. However, for a wideband signal having a relatively high bandwidth, the phase difference resulting from time delay τ_{N} is different for carrier frequency f_{c} than for another frequency f_{c}′ that is offset from carrier frequency f_{c} but that is still within the bandwidth of the signals. As such, the phase shifters may be unable to completely compensate the phase difference at frequency f_{c}′ to create a coherent combined signal at radio-frequency signal port 90, which results in beam squinting where the array gain is frequency-dependent due to the frequency-dependency of beam steering. In other words, the beam will effectively exhibit peak gain in different directions at different frequencies within the bandwidth.

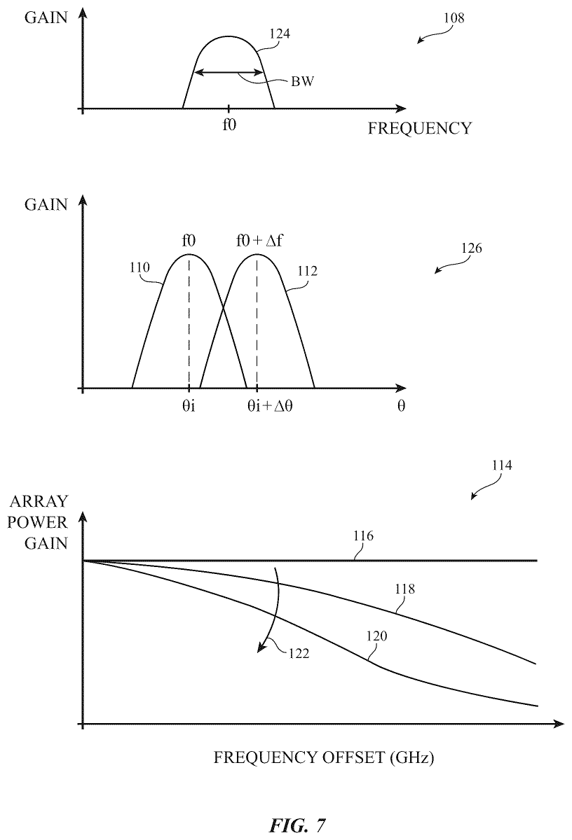

FIG. 7 shows plots that help to illustrate the beam squinting effect. Curve 124 of plot 108 plots the gain of a wide band signal centered at frequency f0 and having a relatively wide bandwidth BW. Plot 126 of FIG. 7 shows how the effective direction of the beam may change at different frequencies within bandwidth BW.

Curve 110 of plot 126 shows the array gain of phased antenna array 88 at the center frequency f0 of bandwidth BW. As shown by curve 110, the signal beam has peak gain at a first beam pointing angle (e.g., elevation angle θi) at center frequency f0 (e.g., the intended nominal beam pointing angle of the array as configured using phase and magnitude controllers 92). Curve 112 shows the array gain of phased antenna array 88 at another frequency within bandwidth BW that is offset from frequency f0 by frequency offset Δf. As shown by curve 112, the signal beam has peak gain at a second beam pointing angle (e.g., elevation angle θi plus an offset Δθ) at frequency f0+Δf. This is the beam squinting phenomenon, which effectively produces a gain loss at the intended nominal beam pointing angle (e.g., elevation angle θi) at frequency f0+Δf.

Beam squinting occurs for ULA, UPA, and other array geometries. For the simplest case ULA, when the phase and magnitude controllers configure the array to exhibit a nominal beam pointing angle (e.g., elevation angle θi), beam squinting produces a squinting error approximated by Δθ=−[tan (θi)]/f0−Δf. The actual beamforming gain of the array thereby varies across frequency due to beam squinting effects. In general, beam squinting effects become more severe as the number N of antennas 86 in the array increases. Beam squinting effects also depend on the nominal beam pointing angle (e.g., are greater for higher elevation angles θi and/or azimuth angles than lower angles). Large frequency offsets Δf (e.g., frequencies closer to the edge of bandwidth BW) may also experience greater reduction in array gain than frequencies closer to frequency f0.

Plot 114 of FIG. 7 plots the gain of phased antenna array 88 as a function of frequency offset Δf from frequency f0 for different intended beam pointing angles (e.g., different nominal elevation angles θi as set by the phase and magnitude controllers). Curve 116 plots the gain of phased antenna array 88 at or near boresight of the array (e.g., where θi=0). Curve 118 plots the gain of phased antenna array 88 at an inclined beam pointing angle (e.g., θi=10 degrees). Curve 120 plots the gain of phased antenna array 88 at a more inclined beam pointing angle (e.g., θi=80 degrees). As shown by curves 116-120, adjusting the phase and magnitude controllers to increase the inclination/tilt of the signal beam (e.g., increasing θi) causes increased reduction in array gain (e.g., in the direction of arrow 122) due to the beam squinting effect, particularly as frequency offset Δf increases (e.g., at frequencies farther from frequency f0 and closer to the edges of bandwidth BW). Similar effects also occur for a UPA or other array geometries.

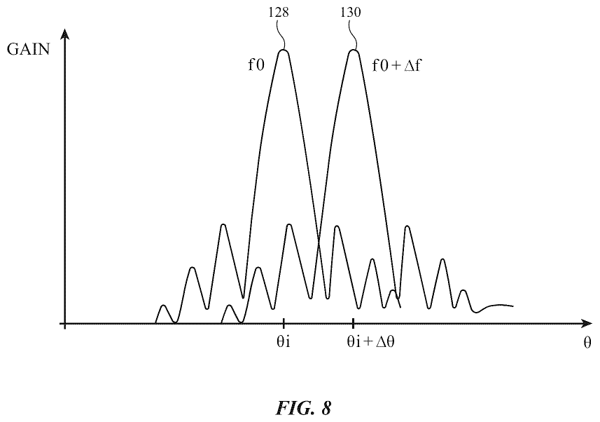

Beam squinting effects may also be present for the antenna elements 48 in RIS 50. For example, curve 128 of FIG. 8 plots the RIS array gain of RIS 50 at frequency f0. Curve 130 of FIG. 8 plots the RIS array gain of RIS 50 at frequency f0+Δf. As shown by curves 128 and 130, the peak gain of the reflection of incident wireless signals by RIS 50 will vary at least between a nominal angle (e.g., θi) and a different angle (e.g., θi+Δθ) at different frequencies across the bandwidth BW of the signals due to beam squint.

If care is not taken, gain reduction due to beam squint can deteriorate the wireless performance of TX device 100 and/or RX device 102 (FIG. 6). Some communications systems attempt to mitigate beam squint to optimize wireless performance. For example, some communications systems may utilize true time delay (TTD) techniques to remove beam squint. However, a perfect TTD solution to beam squint may not be feasible in practice. This is because analog TTD is prone to process-voltage-temperature variation, delay variation, high power consumption, and noise, and digital TTD is costly due to the high number of required RF chains. It would therefore be desirable to be able to reduce the impact of beam squint on wireless performance and to achieve a more efficient signal transmission from TX device 100 to RX device 102 without implementing a TTD technique. TX device 100 and RX device 102 may, for example, leverage beam squint in a manner that optimizes wireless communications between the devices.

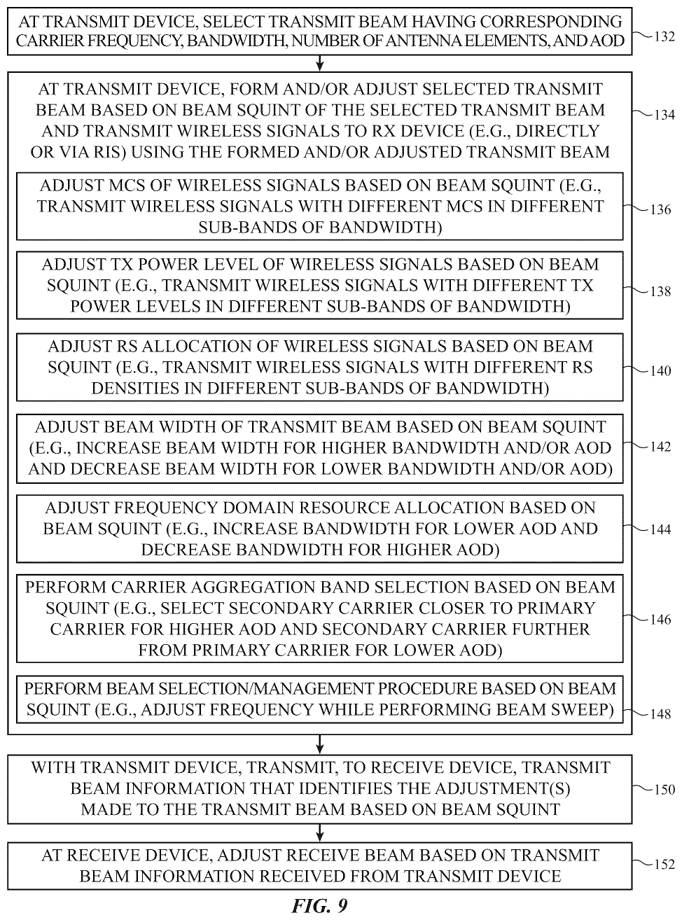

FIG. 9 is a flow chart of illustrative operations involved in conveying wireless signals 46 from TX device 100 to RX device 102 in a manner that leverages beam squint to optimize wireless performance by the devices.

At operation 132, TX device 100 may select a TX beam 104 to use in transmitting wireless signals 46 to RX device 102. RX device 102 may also select a RX beam 105 to use in receiving wireless signals 46 from TX device 100. TX device 100 and RX device 102 may, for example, perform a beam scanning or beam selection operation to select a TX beam 104 oriented towards RX device 102 and an RX beam 105 oriented towards TX device 100 (e.g., using one or more beam sweeps of one or more TX and RX beams, gathering wireless performance metric data during the beam sweeps, and selecting the beams that exhibit the strongest wireless performance metric data).

The selected TX beam 104 has a corresponding AOD (e.g., characterized by elevation angle θ0 and azimuthal angle ϕ0), is formed by a N antennas 86 (FIG. 5) on TX device 100, has a corresponding carrier frequency F0, and has a corresponding bandwidth BW around carrier frequency F0. Bandwidth BW may be sufficiently large (e.g., at least 1 GHZ) and N may be sufficiently large (e.g., at least four) such that TX beam 104 exhibits non-negligible beam squint. Bandwidth BW may span a set of two or more sub-bands SB (e.g., the total frequency range spanned by bandwidth BW may be sub-divided into channel sub-bands as dictated by the communications protocol governing wireless signals 46).

At operation 134, TX device 100 may form the selected TX beam 104. TX device 100 may begin transmitting wireless signals 46 over the selected TX beam 104. RX device 102 may begin receiving wireless signals 46 over its corresponding RX beam 105. TX device 100 may form and/or may adjust TX beam 104 and/or may adjust the transmitted wireless signals 46 based on the beam squint of its phased antenna array 88 and TX beam 104 (e.g., the beam squint of the array as given by the array geometry, the AOD of the TX beam, N, frequency f0, and bandwidth BW). TX device 100 may adjust the transmitted wireless signals 46 and/or the selected TX beam based on beam squint prior to transmitting wireless signals 46 and/or may adjust (e.g., update) wireless signals 46 and/or the selected TX beam based on beam squint after TX device 100 has already begun transmitting wireless signals 46 (e.g., while transmitting wireless signals 46).

TX device 100 may perform any desired adjustment, modification, tuning, and/or update to wireless signals 46 and/or TX beam 104 based on beam squint. For example, TX device 100 may perform any desired combination of one or more of operations 136-148. Two or more of operations 136-148 may be performed concurrently or in series (sequence) if desired. One or more of operations 136-148 may be omitted.

At operation 150, which may be performed after operation 134 and/or concurrent with operation 134, TX device 100 may transmit TX beam information to RX device 102. The TX beam information may identify the adjustment(s) made to TX beam 104 based on beam squint (e.g., as performed at any of operations 136-150). TX device 100 may transmit the TX beam information within wireless signals 46 (e.g., using the data RAT) or using other signals (e.g., signals transmitted over control RAT 60 of FIG. 2). When transmitting the TX beam information within wireless signals 46, TX device 100 may transmit the TX beam information using radio resource control (RRC) signaling/messages, media access control (MAC) control element (CE) signaling/messages, downlink channel information (DCI) signaling/messages (e.g., when TX device 100 is a base station and RX device 102 is a UE device), uplink channel information (UCI) signaling/messages (e.g., when TX device 100 is a UE device and RX device 102 is a base station), and/or any other desired signaling or messages within wireless signals 46.

At operation 152, RX device 102 may adjust its RX beam 105 (FIG. 6) based on the TX beam information received from TX device 100. Operation 150 and/or operation 152 may be omitted if desired.

Returning to the adjustments performed while processing operation 134, at operation 136, the transmitter on TX device 100 may adjust the modulation coding scheme (MCS) of the wireless signals 46 transmitted in TX beam 104 based on the beam squint of phased antenna array 88. This may include, for example, varying the MCS of wireless signals 46 across frequencies (e.g., sub-bands) within bandwidth BW.

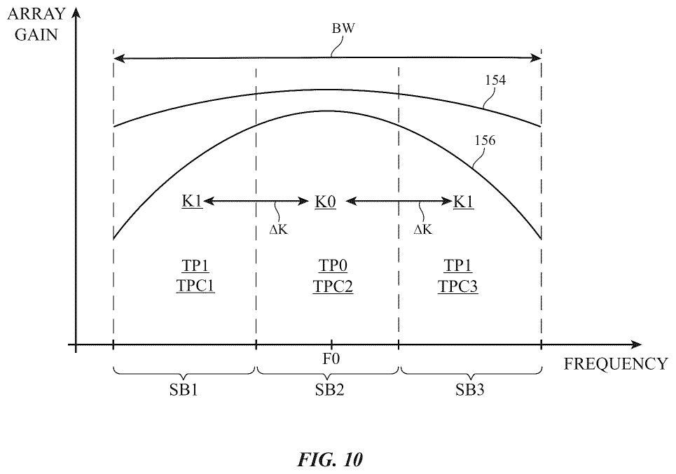

FIG. 10 is a plot showing one example of how TX device 100 may vary the MCS of wireless signals 46 across bandwidth BW. The frequencies of bandwidth BW are divided into a set of sub-bands SB such as a sub-band SB2 centered on frequency F0 and sub-bands SB1 and SB2 around sub-band SB2. This is illustrative and, in practice, bandwidth BW may include additional sub-bands around sub-bands SB2 and/or only two sub-bands.

Curve 154 of FIG. 10 plots the array gain of the phased antenna array 88 on TX device 100 as a function of frequency at a relatively low AOD (e.g., a relatively low elevation angle θ0 such as θ0=10 degrees and/or a relatively low azimuthal angle ϕ0). As shown by curve 154, the relatively low AOD limits beam squint and thus the drop in array gain across bandwidth BW.

Curve 156 plots the array gain of the phased antenna array 88 on TX device 100 at a relatively high AOD (e.g., a relatively high elevation angle θ0 such as θ0=60 degrees and/or a relatively high azimuthal angle ϕ0). As shown by curve 154, the relatively high AOD produces a relatively large beam squint and thus a relatively large drop in array gain at frequencies within bandwidth BW that are relatively far from frequency F0, such as frequencies in sub-bands SB1 and SB2.

If/when phased antenna array 88 exhibits more than a threshold amount of beam squint (e.g., if/when the AOD exceeds a threshold AOD and/or exhibits a gain profile similar to that shown by curve 156), the transmitter on TX device 100 may vary the MCS of the wireless signals 46 transmitted within TX beam 104 across the frequencies of bandwidth BW. For example, TX device 100 may transmit wireless signals 46 with a first MCS k0 within sub-band SB2 and with a different MCS k1 within sub-bands SB1 and SB2. MCS k0 may, for example, be a higher order modulation coding scheme than MCS k1. The order of MCS k1 may differ from that of MCS k2 by difference Δk. On the other hand, TX device 100 may transmit wireless signals 46 with a uniform MCS k0 across sub-bands SB1-SB3 when the AOD is less than the threshold AOD (e.g., when phased antenna array 88 exhibits the gain profile associated with curve 154).

TX device 100 may actively adjust the MCS used across bandwidth BW as the AOD changes over time (e.g., may transmit wireless signals 46 using MCS k0 in sub-band SB2 and using MCS k1 in sub-bands SB1 and SB3 at a first time when TX beam 104 is at a relatively high beam pointing angle and may switch to transmitting wireless signals 46 using a single MCS k0 across bandwidth BW at a second time when/after TX beam 104 switches to a relatively low beam pointing angle). This may be generalized to any desired number of MCS's across any desired number of SB's within bandwidth BW (e.g., where the MCS generally decreases at farther frequencies from frequency F0). This may, for example, serve to leverage beam squint to produce a more efficient transmission and reception of wireless signals 46 across bandwidth BW when TX beam 104 is at or switches to a relatively high AOD than in implementations where the same MCS is used across all AOD's and frequencies within bandwidth BW.

If desired, TX device 100 may transmit TX beam information to RX device 102 that identifies the MCS(s) of wireless signals 46 across bandwidth BW (e.g., while processing operation 150 of FIG. 9). As one example, TX device 100 may transmit sets of one or more bits that each identify the absolute MCS value (e.g., values k) for each of the sub-bands across bandwidth BW. As another example, TX device 100 may transmit a single absolute MCS value (e.g., value k0) for the sub-band containing the carrier frequency (e.g., sub-band SB2 containing frequency F0) and an MCS offset value (e.g., value Δk) for each of the remaining sub-bands. Since value Δk can be represented using fewer bits than an absolute MCS value (e.g., values k), this may involve less signaling overhead than separately identifying the MCS used for each sub-band. In yet another example, the MCS assignment may be symmetric around the sub-band containing the carrier frequency. In this example, the absolute MCS value of the sub-band containing the carrier frequency is signaled to RX device 102 and MCS offset values Δk only need to be signaled for half of the remaining sub-bands, further reducing signaling overhead (e.g., RX device 102 may already be aware that the same MCS is applied in sub-bands SB1 and SB2 given the symmetric MCS assignment).

Returning to FIG. 9, at operation 138, the transmitter on TX device 100 may adjust the transmit (TX) power level of the wireless signals 46 transmitted in TX beam 104 based on the beam squint of phased antenna array 88. This may include, for example, varying the TX power level and/or transmit power command (TPC) of wireless signals 46 across frequencies (e.g., sub-bands) within bandwidth BW.

FIG. 10 also illustrates one example of how TX device 100 may vary the TX power level and/or TPC's of wireless signals 46 across bandwidth BW. If/when phased antenna array 88 exhibits more than a threshold amount of beam squint (e.g., if/when the AOD exceeds a threshold AOD and/or exhibits a gain profile similar to that shown by curve 156), the transmitter on TX device 100 may vary the TX power level of the wireless signals 46 transmitted within TX beam 104 across the frequencies of bandwidth BW. In some implementations, TX device 100 may transmit wireless signals 46 with a first TX power level TP0 within sub-band SB2 and with a different TX power level TP1 within sub-bands SB1 and SB2. TX power level TP0 may, for example, be higher than TX power level TP1. This may, for example, allow for a water-filling gain. In other implementations, TX power level TP0 may be less than TX power level TP1. This may, for example, help to compensate for loss due to beam squinting to achieve equal-gain transmission across bandwidth BW.

TX device 100 may actively adjust the TX power level and/or TPC's used across bandwidth BW as the AOD changes over time (e.g., may transmit wireless signals 46 using TP0 in SB2 and using TP1 in SB1 and SB3 at a first time when TX beam 104 is at a relatively high beam pointing angle and may switch to transmitting wireless signals 46 using a TX power level TP0 across bandwidth BW at a second time when/after TX beam 104 switches to a relatively low beam pointing angle). This may be generalized to any desired number of TX power levels and/or TPC's across any desired number of SB's within bandwidth BW. This may, for example, serve to leverage beam squint to produce a more efficient transmission and reception of wireless signals 46 across bandwidth BW when TX beam 104 is at or switches to a relatively high AOD than in implementations where the same TX power level and/or TPC is used across all AOD's and frequencies within bandwidth BW.

This beam-squinting aware TX power control may apply to both DL and UL transmission. In addition, for closed loop UL power control, the UE device may receive a single TPC (e.g., as transmitted by the base station while processing operation 150 of FIG. 9, where the TPC's form part of the TX beam information) and the different power levels allocated to other sub-bands may be determined at the UE device (e.g., based on the implementation at the UE device) without the UE device informing the base station. Alternatively, the UE device may receive multiple sub-band based TPC's from the base station (e.g., TPC1 for SB1, TPC2 for SB2, TPC3 for SB3, etc.) that inform the UE device of the different TX power levels used across bandwidth BW.

Returning to FIG. 9, at operation 140, the transmitter on TX device 100 may adjust the reference signal (RS) allocation of the wireless signals 46 transmitted in TX beam 104 based on the beam squint of phased antenna array 88. This may include, for example, varying the RS density of wireless signals 46 across frequencies (e.g., sub-bands) within bandwidth BW. The reference signals may include demodulation reference signals (DMRS), channel state information reference signals (CSI-RS), sounding reference signals (SRS), positioning reference signals (PRS), phase tracking reference signals (PTRS), synchronization signals (e.g., synchronization signal blocks (SSBs)), and/or other reference signals (e.g., as defined by the communication protocol governing wireless signals 46).

FIG. 11 is a frequency diagram showing one example of how TX device 100 may vary the RS density of wireless signals 46 across bandwidth BW. Block 162 represents the wireless signals transmitted within SB1. Block 158 represents the wireless signals 46 transmitted within SB2. Block 160 represents the wireless signals 46 transmitted with SB3. TX device 100 may transmit reference signals RS at different frequencies across bandwidth BW.

Rather than transmitting reference signals RS at the same uniform density across the frequencies of bandwidth BW, TX device 100 may leverage beam squint by transmitting reference signals RS with different densities across bandwidth BW. For example, if/when phased antenna array 88 exhibits more than a threshold amount of beam squint (e.g., if/when the AOD exceeds a threshold AOD), the transmitter on TX device 100 may vary the density of the reference signals RS transmitted within wireless signals 46 across the frequencies of bandwidth BW. For example, TX device 100 may transmit wireless signals 46 with a first reference signal density within SB2 and with a second reference signal density within SB1 and SB2. The second reference signal density (in SB1 and SB2) may, for example, be higher than the first reference signal density (in SB2). On the other hand, TX device 100 may transmit wireless signals 46 with a uniform reference signal density across sub-bands SB1-SB3 and bandwidth BW when the AOD is less than the threshold AOD (e.g., when phased antenna array 88 exhibits less than a threshold amount of beam squint).

TX device 100 may actively adjust the reference signal density used across bandwidth BW as the AOD changes over time (e.g., may transmit wireless signals 46 using different reference signal densities across bandwidth BW at a first time when TX beam 104 is at a relatively high beam pointing angle and may switch to transmitting wireless signals 46 using a single uniform reference signal density across bandwidth BW at a second time when/after TX beam 104 switches to a relatively low beam pointing angle). This may be generalized to any desired number of reference signal densities across any desired number of SB's within bandwidth BW (e.g., where the reference signal density generally decreases at farther frequencies from frequency F0). Utilizing a higher reference signal density farther from frequency F0 may, for example, help to guarantee acceptable channel estimation performance despite the degraded array gain produced by beam squint. This may, for example, serve to leverage beam squint to produce a more efficient transmission and reception of wireless signals 46 across bandwidth BW when TX beam 104 is at or switches to a relatively high AOD than in implementations where the same reference signal density is used across all AOD's and frequencies within bandwidth BW.

If desired, TX device 100 may transmit TX beam information to RX device 102 that identifies the reference signal density of wireless signals 46 across bandwidth BW (e.g., while processing operation 150 of FIG. 9). As one example, TX device 100 may transmit sets of one or more bits that each identify the absolute reference signal density for each of the sub-bands across bandwidth BW. As another example, TX device 100 may transmit a single absolute reference signal density value for the sub-band containing the carrier frequency (e.g., sub-band SB2 containing frequency F0) and a value identifying the reference signal density increase(s) for the remaining sub-bands. Since the difference between reference signal densities can be represented using fewer bits than absolute reference signal density values, this may involve less signaling overhead than separately identifying the reference signal density used for each sub-band.

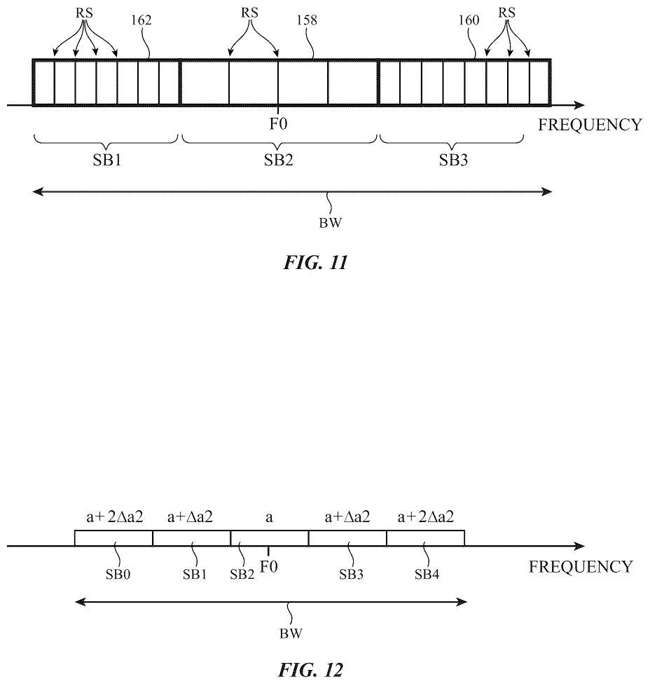

In yet another example, the combinations of RS frequency densities across sub-bands may be pre-configured via RRC and/or MAC-CE. Then, a pointer towards which combination is applied may be signaled by the base station to the UE device via DCI. For example, a first index value may correspond to reference signal density a in SB2, a shift by a first amount (a+Δa1) in the adjacent sub-bands, then by (a+2Δa1) in the next sub-bands, and so on, a second index value may correspond to a reference signal density a in SB2, a shift by a second amount (a+Δa2) in the adjacent sub-bands, then by (a+2Δa2) in the next sub-bands, and so on, a third index value may correspond to a reference signal density a in SB2, a shift by a third amount (a+Δa3) in the adjacent sub-bands, then by (a+2Δa3) in the next sub-bands, etc. FIG. 12 shows one example of how reference signal distribution in sub-bands SB0-SB4 around the SB2 containing frequency F0 may be represented by the second index value. In this example, the base station need only transmit the second index value to the UE device (e.g., via DCI) to inform the UE device of the reference signal densities across bandwidth BW. Since the index values can be represented by very few bits, this may serve to minimize signal overhead in informing the UE device of the reference signal density used for wireless signals 46.

Returning to FIG. 9, at operation 142, the transmitter on TX device 100 may adjust the beam width of TX beam 104 and/or the receiver on RX device 102 may adjust the beam width of RX beam 105 based on beam squint. This may include, for example, increasing the beam width when bandwidth BW is relatively high (or switches to a higher bandwidth) and/or when the beam has a relatively high AOD/AOA (or switches to a higher AOD/AOA). Conversely, this may include decreasing the beam width when bandwidth BW is relatively low (or switches to a lower bandwidth) and/or when the beam has a relatively low AOD/AOA (or switches to a lower AOD/AOA). This may serve to minimize the impact of beam squint on the transmission and reception of wireless signals 46.

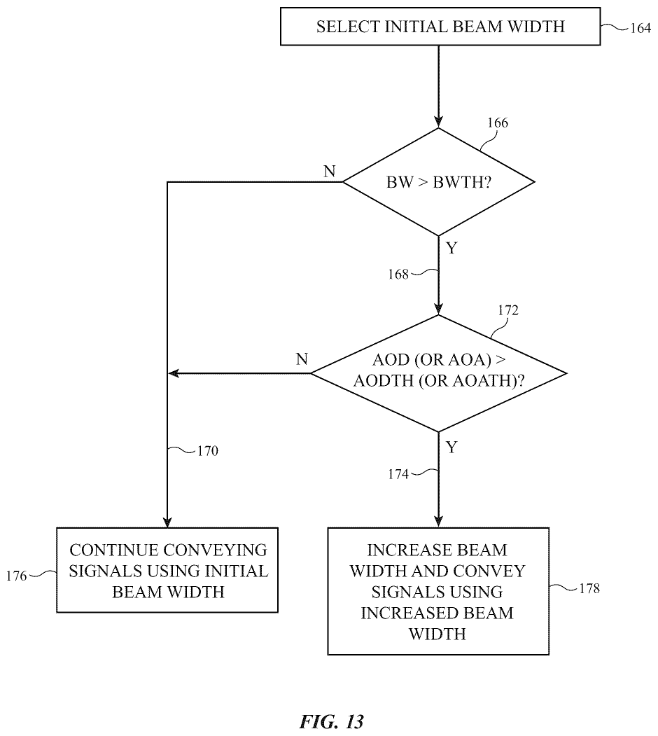

FIG. 13 is a flow chart of operations that may be performed by TX device 100 and RX device 102 to adjust beam width based on beam squint. The operations of FIG. 13 may, for example, be performed by TX device 100 to adjust the beam width of TX beam 104. The operations of FIG. 13 may be performed in parallel by RX device 102 to adjust the beam width of RX beam 105. The operations of FIG. 13 may be performed while processing operation 142 of FIG. 9.

At operation 164, TX device 100 may select an initial beam width for TX beam 104. RX device 102 may select an initial beam width for RX beam 105.

At operation 166, TX device 100 and/or RX device 102 may determine whether the bandwidth BW of wireless signals 46 exceeds a threshold bandwidth BWTH (e.g., a threshold bandwidth at which beam squint exceeds a threshold amount of beam squint). If/when bandwidth BW is less than or equal to threshold bandwidth BWTH, processing may proceed to operation 176 via path 170.

At operation 176, TX device 100 may continue to transmit wireless signals using the initial beam width for TX beam 104. RX device 102 may continue to receive wireless signals using the initial beam width for RX beam 105. Since bandwidths less than threshold bandwidth BWTH do not produce significant beam squint, wireless signals 46 may be conveyed from TX device 100 to RX device 102 with satisfactory levels of performance. If/when bandwidth BW exceeds threshold bandwidth BWTH, processing proceeds from operation 166 to operation 172 via path 168.

At operation 172, TX device 100 may determine whether the AOD of TX beam 104 exceeds a threshold AODTH (e.g., a threshold AOD at which beam squinting exceeds a threshold amount of beam squinting). If the AOD does not exceed threshold AODTH, processing proceeds to operation 176 via path 170 and TX device 100 continues to use the current beam width of TX beam 104 (e.g., since an AOD less than threshold AODTH does not produce significant beam squint).

RX device 102 may concurrently determine whether the AOA of RX beam 105 exceeds a threshold AOATH (e.g., a threshold AOA at which beam squinting exceeds a threshold amount of beam squinting). If the AOA does not exceed threshold AOATH, processing proceeds to operation 176 via path 170 and RX device 102 continues to use the current beam width of RX beam 105 (e.g., since an AOA less than threshold AOATH does not produce significant beam squint).

If the AOD exceeds threshold AODTH, processing proceeds from operation 172 to operation 178 via path 174 for TX device 100. TX device 100 may increase the beam width of TX beam 104 to help mitigate beam squint and may transmit wireless signals 46 using the TX beam 104 having increased beam width. Similarly, if the AOA exceeds threshold AOATH, processing proceeds from operation 172 to operation 178 via path 174 for RX device 102. RX device 102 may increase the beam width of RX beam 105 to help mitigate beam squint and may receive wireless signals 46 using the RX beam 105 having increased beam width. Thresholds BWTH, AOATH, and AODTH may be predetermined thresholds. This may, for example, serve to leverage beam squint to produce a more efficient transmission and reception of wireless signals 46 across bandwidth BW when the beam switches to a relatively high AOD/AOA and/or a relatively high bandwidth BW than in implementations where the same beam width is used across all AOD's, AOA's, and bandwidths.

Returning to FIG. 9, at operation 144, the transmitter on TX device 100 may adjust the frequency domain resource allocation of wireless signals 46 transmitted in TX beam 104 (e.g., bandwidth BW) based on the beam squint of phased antenna array 88. This may include, for example, varying the frequency allocation (e.g., bandwidth) of wireless signals 46 based on the AOD of TX beam 104.

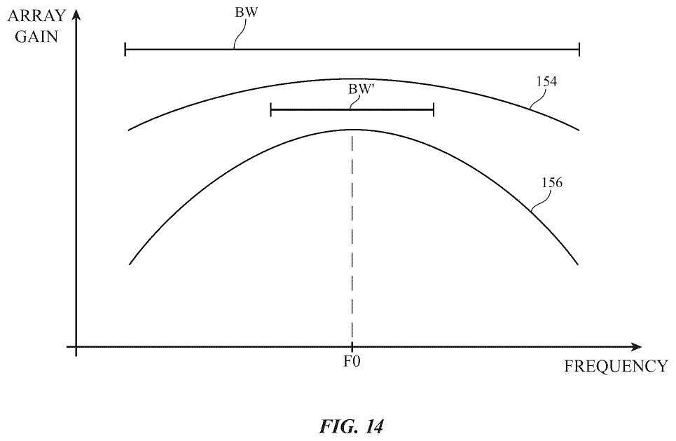

FIG. 14 is a plot showing one example of how TX device 100 may vary the frequency domain resource allocation of wireless signals 46 based on beam squint. As shown in FIG. 14, when TX beam has a relatively low AOD (e.g., less than threshold AODTH) and thus relatively low beam squint (e.g., less than a threshold amount of beam squint), the array gain of TX device 100 is represented by curve 154. On the other hand, when TX beam has a relatively high AOD (e.g., greater than threshold AODTH) and thus relatively high beam squint (e.g., greater than a threshold amount of beam squint), the array gain of TX device 100 is represented by curve 156.

TX device 100 may adjust the bandwidth of the transmitted wireless signals 46 based on the AOD and thus the amount of beam squint of TX beam 104. For example, if/when phased antenna array 88 exhibits the array gain shown by curve 154 (e.g., less than a threshold amount of beam squint and/or an AOD less than threshold AODTH), TX device 100 may allocate a relatively wide bandwidth BW to wireless signals 46 and may transmit wireless signals 46 across bandwidth BW. On the other hand, if/when phased antenna array 88 exhibits the array gain shown by curve 156 (e.g., more than a threshold amount of beam squint and/or an AOD greater than threshold AODTH), TX device 100 may allocate a relatively narrow bandwidth BW′ to wireless signals 46 and may transmit wireless signals 46 across bandwidth BW′.

TX device 100 may actively adjust the bandwidth of wireless signals 46 as the AOD changes over time (e.g., may transmit wireless signals 46 using bandwidth BW at a first time when TX beam 104 is at a relatively low beam pointing angle and may switch to transmitting wireless signals 46 using bandwidth BW′ at a second time after TX beam 104 has switched to a relatively high beam pointing angle). This may be generalized to any desired number of bandwidths for any desired number of AOD's of TX beam 104 (e.g., where the bandwidth generally decreases as AOD increases). This may, for example, help to minimize the deterioration of wireless performance created by beam squint as the TX beam is switched between different AOD's.

Returning to FIG. 9, at operation 146, the transmitter on TX device 100 and/or the receiver on RX device 102 may perform carrier aggregation band selection based on the beam squint of phased antenna array 88. This may include, for example, selection of a secondary component carrier (SCC) based on the amount of beam squint and/or the AOD of TX beam 104. Under carrier aggregation (CA), a device connects with a first base station or cell (sometimes referred to as a primary cell (Pcell)) and conveys radio-frequency signals with that base station or cell using a first carrier frequency, referred to as a primary component carrier (PCC). The device then connects with a second base station or cell (sometimes referred to as a secondary cell (Scell)) and concurrently conveys radio-frequency signals with that base station or cell using a second carrier frequency, referred to as a secondary component carrier (SCC). The PCC and the SCC may be inter-band or intra-band (e.g., intra-band contiguous or intra-band dis-contiguous). The PCC and SCC may belong to the same RAT or may belong to separate RATs such as 4G and 5G RATs (e.g., under a dual connectivity CA scheme).

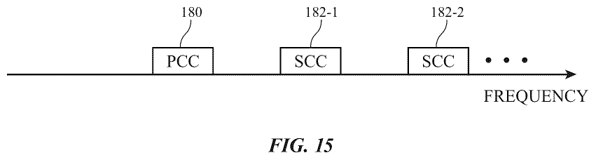

FIG. 15 is a frequency diagram showing one example of how TX device 100 and/or RX device 102 may perform carrier aggregation band selection based on beam squint. As shown in FIG. 15, the device may connect to a PCC 180 at a first frequency. There may be a set of SCC's 182 at other frequencies such as at least a first SCC 182-1 and a second SCC 182-2 farther from PCC 180 than SCC 182-1. The device may select an SCC based on the AOD or AOA of the corresponding beam and the bandwidth of each component carrier (CC). Note that, due to beam squinting effects, the TX array gain at a secondary carrier may be small depending on AOD, array size, carrier channel bandwidth, and frequency gap relative to the PCC.

In one example, if AOD/AOA is larger than a predetermined threshold, the device may select an SCC that is relatively close to the PCC (e.g., SCC 182-1) for use in performing CA. This may help to limit the overall bandwidth across the PCC and the SCC to minimize detrimental beam squint effects on wireless performance given the high AOD/AOA. On the other hand, if the AOD/AOA is less than the threshold, the device may select an SCC that is relatively far from the PCC (e.g., SCC 182-2).

In another example, if AOD/AOA is larger than a predetermined threshold, the device may forego selection of an SCC and may instead communicate using only the PCC (e.g., without performing CA). This may help to limit the overall bandwidth of the device to minimize detrimental beam squint effects on wireless performance given the high AOD/AOA.

In another example, if the channel bandwidth of the PCC is greater than a predetermined threshold, the device may select an SCC that is relatively close to the PCC (e.g., SCC 182-1) for use in performing CA communications. This may help to limit the overall bandwidth across the PCC and the SCC to minimize detrimental beam squint effects on wireless performance given the high channel bandwidth of the PCC.

In yet another example, if the channel bandwidth of the PCC is greater than a predetermined threshold, the device may forego selection of an SCC and may instead communicate using only the PCC (e.g., without performing CA). This may help to limit the overall bandwidth of the device to minimize detrimental beam squint effects on wireless performance given the channel bandwidth of the PCC.

Returning to FIG. 9, at operation 148, TX device 100 and/or RX device 102 may perform beam selection/management operations based on the beam squint of phased antenna array(s) 88. When beam squint is not leveraged, the beam selection/management operations involve an exhaustive sweep of the phase and magnitude controllers coupled to the array(s) to sweep the array(s) over all possible beams in the sphere or hemisphere around the array until the beam pointing towards the other device is found. This can consume an excessive amount of time and cause excessive delays in establishing or maintaining communications between TX device 100 and RX device 102.

Performing beam selection/management based on the beam squint of phased antenna array 88 may include, for example, adjusting the frequency of wireless signals 46 while performing one or more beam sweeps of TX beam 104 and/or RX beam 105 (e.g., during initialization of communications between TX device 100 and RX device 102 to identify a TX beam 100, periodically after initialization of communications to ensure that communications are maintained between TX device 100 and RX device 102, and/or to account for the mobility of the TX device and/or the RX device to ensure that TX beam 104 continues to point towards RX device 102 and that RX beam 105 continues to point towards TX device 100 as one or both of the devices move over time). The adjustment to frequency may, via beam squint, effectively steer the direction of the beams without requiring readjustment to the phase and magnitude controllers 92 on TX device 100 and RX device 102. This may be used to cover all or substantially all of the same angles around the array as when an exhaustive beam sweep is performed but with fewer adjustments to the phase and magnitude controllers. This may significantly decrease the amount of time required to perform the beam sweep(s) before the desired beam(s) are found.

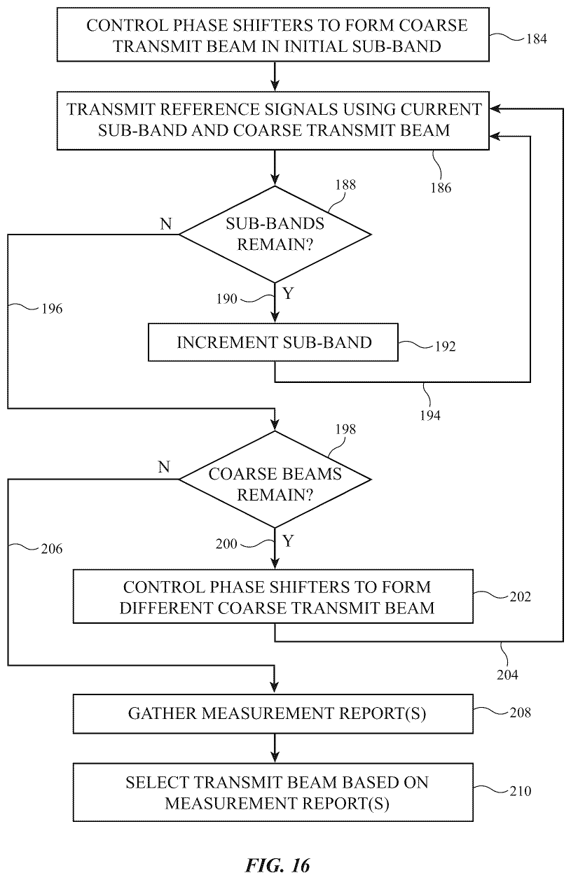

FIG. 16 is a flow chart of operations involved in performing beam selection/management based on beam squint using TX device 100. The operations of FIG. 16 may, for example, be performed by TX device 100 while processing operation 148 of FIG. 9. Similar operations may also be performed by RX device 102 to perform beam selection/management.

At operation 184, TX device 100 may control the phase and magnitude controllers 92 coupled to its phased antenna array 88 (FIG. 5) to exhibit first phase and magnitude settings. The first phase and magnitude settings may configure phased antenna array 88 to form an initial TX beam 104. The TX beams that are formed via re-adjustment to the phase and magnitude settings of phase and magnitude controllers 92 are sometimes referred to herein as coarse TX beams or sparse TX beams. TX device 100 may form the initial TX beam in an initial sub-band of the bandwidth BW of wireless signals 46 (e.g., phase and magnitude controllers 92 may set the first phase and magnitude settings based on a carrier frequency in the initial sub-band).

At operation 186, TX device 100 may transmit reference signals in wireless signals 46 using the initial TX beam and the initial sub-band. The beam squint of the phased antenna array may cause TX device 100 to transmit the reference signals in the initial sub-band at a first AOD. The reference signals may include CSI-RS or multiple simultaneous SSBs, as examples.

At operation 188, TX device 100 may determine if sub-bands remain across the bandwidth BW of wireless signals remain for processing. If/when sub-bands remain, processing proceeds to operation 192 via path 190.

At operation 192, TX device 100 may increment the sub-band to a different sub-band within bandwidth BW. Processing then loops back to operation 186 via path 194 to transmit the reference signals using the initial TX beam and the incremented sub-band. The beam squint of the phased antenna array may cause TX device 100 to transmit wireless signals 46 in the incremented sub-band at a second AOD (e.g., while the phase and magnitude controllers continue to exhibit the first phase and magnitude settings). The second AOD may be different from the first AOD associated with the initial sub-band but may be closer to the first AOD than a different coarse TX beam (e.g., than when the phase and magnitude controllers exhibit different phase and magnitude settings). TX device 100 may continue to iterate over operations 186-192 until each sub-band has been used to transmit the reference signals. Once no sub-bands remain, processing proceeds from operation 188 to operation 198 via path 196.

At operation 198, TX device 100 may determine if coarse TX beams remain for processing. If/when coarse TX beams remain, processing proceeds to operation 202 via path 200.

At operation 202, TX device 100 may increment the coarse TX beam. This may involve controlling the phase and magnitude controllers of phased antenna array 88 to exhibit second phase and magnitude settings, causing phased antenna array 88 to form the incremented coarse TX beam. Processing then loops back to operation 186 via path 204 to transmit reference signals using the incremented TX beam while sweeping over sub-bands. TX device 100 may continue to iterate over operations 186-202 until each sub-band of each coarse TX beam has been used to transmit reference signals. Once no sub-bands remain, processing proceeds from operation 198 to operation 208 via path 206.

At operation 208, TX device 100 may gather (e.g., receive) measurement report(s) from RX device 102. The measurement report(s) may be generated by RX device 102 from different combinations of coarse TX beam and sub-band. The measurement report(s) may include or may be generated based on wireless performance metric data gathered by RX device 102 from the reference signals transmitted by TX device 100. The wireless performance metric data may include received signal strength values, received power levels, received signal strength indicator (RSSI) values, error rate values, reference signal received power (RSRP) values, signal-to-noise ratio (SNR) values, signal-to-interference-plus-noise (SINR) values, and/or any other desired data indicative of the performance of RX device 102 in receiving wireless signals 46.

RX device 102 may transmit the measurement report(s) to TX device 100 using wireless signals 46 (e.g., using the data RAT) and/or using control RAT 60 (FIG. 2). If desired, RX device 102 may transmit one or more measurement reports and TX device 100 may receive the measurement report(s) periodically during the coarse TX beam and sub-band sweeps (e.g., concurrent with any of operations 186-202) and/or may receive the measurement report(s) after the coarse TX beam and sub-band sweeps have been completed.

The example of FIG. 16 is illustrative and non-limiting. In another example, the reference signals may be wideband reference signals that span each of the sub-bands across bandwidth BW. These may include CSI-RS or multiple simultaneous SSB, as examples. The wideband reference signals may allow TX device 100 to forego sweeping over sub-bands (e.g., operations 188-192 may be omitted) and may instead sweep only over coarse TX beams. The coarse TX beams may be spaced farther apart than when the TX device performs a full beam sweep over all phase and magnitude settings, leveraging beam squint effects for different sub-bands of the reference signals to be incident upon RX device 102 at different AOAs. Meanwhile, RX device 102 may sweep over different sub-bands while receiving and measuring the transmitted reference signals. In this way, RX device 102 may gather wireless performance metric data for each combination of sub-band and coarse TX beam without requiring TX device 100 to sweep over frequency while transmitting the reference signals. This may serve to further reduce the amount of time and power required for the beam selection/management procedure.

At operation 210, TX device 100 may select a coarse TX beam and/or a sub-band to use for transmitting wireless signals 46 based on the measurement report(s) received from RX device 102. The selected combination of coarse TX beam and sub-band may be the combination that maximized or optimized the wireless performance metric data identified by the measurement report(s), for example. When the selected sub-band is used, the selected TX beam may, for example, be oriented or pointed towards RX device 102 given the beam squint associated with the selected sub-band. In this way, TX device 100 does not need to update phase and magnitude controllers 92 to cover all AOD's of the TX beam sweep. Instead, TX device 100 can leverage beam squint to sweep over AOD's by transmitting a wideband reference signal (or sweeping over sub-bands) in wireless signals 46 in addition to sweeping over fewer phase and magnitude settings (e.g., fewer TX beams) than are required to cover all AOD's when an exhaustive beam sweep is performed. This may be significantly faster, may consume less power, and/or may involve less signaling overhead than updating the phase and magnitude settings for all AODs.

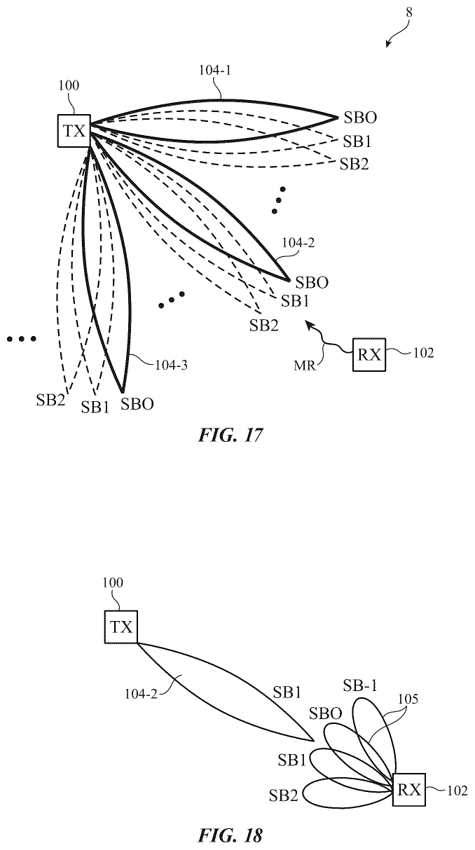

FIG. 17 is a diagram showing how TX device 100 may perform beam management/selection while leveraging beam squint (e.g., while processing the operations of FIG. 16). As shown in FIG. 17, TX device 100 may form an initial coarse TX beam 104-1 at a first time via adjustment to the phase and magnitude controllers on TX device 100. TX device 100 may transmit reference signals over initial coarse TX beam 104-1 within sub-band SB0. TX device 100 may then sweep over different sub-bands SB (e.g., SB1, SB2, etc.) while maintaining the same phase and magnitude settings and the same initial coarse TX beam 104-1 (e.g., while iterating over operations 186-192 of FIG. 16). Due to beam squint, each sub-band will cause the reference signals to be transmitted over a slightly different AOD. Once the sub-bands have been exhausted, TX device 100 may form an incremented coarse TX beam 104-2 at a second time via adjustment to the phase and magnitude controllers on TX device 100 (e.g., at operation 202 of FIG. 16). TX device 100 may transmit reference signals over incremented coarse TX beam 104-2 within sub-band SB0. TX device 100 may then sweep over different sub-bands SB (e.g., SB1, SB2, etc.) while maintaining the same phase and magnitude settings and the same updated coarse TX beam 104-2. This process may continue over additional coarse TX beams such as coarse TX beam 104-3, etc., while sweeping over sub-bands (e.g., while iterating over operations 186-192 of FIG. 16).

Alternatively, when the reference signals are sufficiently wideband, TX device 100 may omit sweeping over sub-bands. Instead, TX device 100 need only sweep over coarse TX beams (e.g., by forming coarse TX beam 104-1 at a first time, then forming coarse TX beam 104-2 at a second time, then forming coarse TX beam 104-3 at a third time, etc.). In these implementations, RX device 102 may measure different frequencies (sub-bands) of the reference signals for each coarse TX beam 104 formed by TX device 100. Beam squint causes the different sub-bands of the reference signals to leave TX device 100 at slightly different AODs around the nominal AOD of the coarse TX beam and to therefore be incident upon RX device at slightly different AOAs.

RX device 102 may gather wireless performance metric data from each combination of sub-band and coarse beam from the coarse beam sweep performed by TX device 100. In the example of FIG. 17, the beam squint of coarse TX beam 104-2 produced when wireless signals 46 are at a frequency in sub-band SB1 causes the TX beam to be oriented towards RX device 102. RX device 102 may therefore gather peak wireless performance metric data from coarse TX beam 104-2 in sub-band SB1. RX device 102 may transmit one or more measurement reports MR to TX device 100 identifying the gathered wireless performance metric data and/or the optimal combination of coarse TX beam 104 and sub-band (e.g., coarse TX beam 104-2 and sub-band SB1). In one example, RX device 102 may transmit a measurement report MR to TX device 100 that identifies only the coarse TX beam and sub-band corresponding to the best or highest wireless performance metric data (e.g., RSRP). In another example, RX device 102 may transmit measurement reports MR to TX device 100 that identify multiple TX beams and/or sub-bands as well as the corresponding wireless performance metric data gathered by RX device 102.

TX device 100 may process the measurement report(s) to identify that sub-band SB1 of coarse TX beam 104-2 optimized performance at RX device 102 and may then use TX beam 104-2 and sub-band SB1 to convey wireless data with RX device 102. When data transmission is narrowband, TX device 100 may apply a narrow beam to data transmission. In one example, TX device 100 may use the reported TX beam for data transmission. In another example, TX device 100 may interpolate multiple reported TX beams to select a more suitable beam. When data transmission is wideband, TX device 100 may apply a narrow beam or a wide beam to data transmission depending on AOD.

FIG. 18 is a diagram showing one example of the operation of RX device 102 during beam selection/management. By utilizing beam squint, RX device 102 may apply a coarse/sparse RX beam sweep for each coarse TX beam 104 swept over by TX device 100. This may serve to reduce the beam sweep time of RX device 102. In the example of FIG. 18, RX device 102 only forms a single RX beam 105 and measures different sub-bands using that RX beam (e.g., from SB-1 to SB2). As shown in FIG. 18, each sub-band of RX beam 105 will be oriented in a different direction due to beam squinting. RX device 102 may gather wireless performance metric data from each sub-band of RX beam 105 and may select an RX beam and/or sub-band to use for conveying wireless data with TX device 100 based on the wireless performance metric data.

Now consider an example in which external device 34 of FIG. 1 is a base station (BS) and device 10 of FIG. 1 is a UE device. External device 34 is therefore sometimes referred to herein as BS 34 and UE device 10 is therefore sometimes referred to herein as UE device 10. In these examples, BS 34 uses a corresponding signal beam to transmit wireless signals 46 to one or more UE devices 10 in a DL direction and one or more UE devices 10 use corresponding signal beams to transmit wireless signals 46 in a UL direction. The wireless signals may be conveyed directly (e.g., without an intervening RIS 50) or via reflection off RIS 50. As UE devices tend to be mobile, the UE devices can move relative to BS 34 and/or RIS 50 over time. The signal beam formed by BS 34 and/or the RIS beam(s) formed by RIS 50 may therefore need to be updated over time to ensure that the beam(s) continue to overlap the location of the UE devices after the UE devices have moved (e.g., using a beam selection/management procedure).

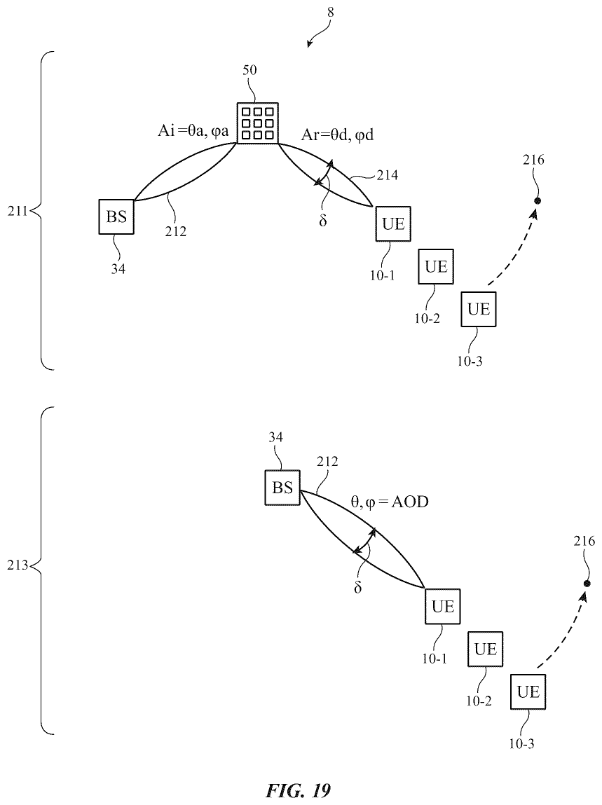

FIG. 19 is a diagram showing how BS 34 may transmit wireless signals 46 to one or more UE devices 10. FIG. 19 illustrates downlink transmission of wireless signals 46 from BS 34 to UE devices 10 for the sake of simplicity and clarity. The systems and methods described herein may equivalently be used for uplink transmission of wireless signals 46 from UE devices 10 to BS 34.

Portion 211 of FIG. 19 illustrates an implementation in which an intervening RIS 50 is used to relay wireless signals 46 from BS 34 to a set of one or more UE devices 10 such UE devices 10-1, 10-2, and 10-3. UE devices 10-1, 10-2, and 10-3 may be co-located or adjacent to each other at an initial time (e.g., such that a single signal beam can serve each UE device).

BS 34 may transmit wireless signals 46 over a BS beam 212 oriented towards RIS 50. RIS 50 may reflect wireless signals 46 incident from BS 34 towards UE devices 10-1, 10-2, and 10-3. To perform this reflection, RIS 50 may form a first RIS beam oriented towards BS 34 (not shown) and a corresponding second RIS beam 214 (e.g., a reflected beam) oriented towards UE devices 10-1, 10-2, and 10-3 (e.g., via appropriate impedance settings for the antenna elements on RIS 50). While implementations in which RIS 50 operates in a reflective mode are described herein as an example, RIS 50 may equivalently be operated in a transmissive mode.

In this example, the wireless signals 46 transmitted by BS 34 within BS beam 212 are incident upon RIS 50 from RIS AOA Ai (e.g., the first RIS beam may be oriented at RIS AOA Ai). RIS AOA Ai may be characterized by a corresponding elevation angle θa and a corresponding azimuthal angle ϕa. RIS 50 may reflect wireless signals 46 from RIS AOA Ai onto the RIS beam 214, which is oriented at RIS AOD Ar. RIS AOD Ar may be characterized by a corresponding elevation angle θd and a corresponding azimuthal angle ϕd. RIS beam 214 may have a corresponding beam width δ. Beam width δ may be sufficiently large so as to overlap each of UE devices 10-1, 10-2, and 10-3. At the same time, beam width δ may be kept sufficiently narrow to maximize gain.

When a UE device such as UE device 10-3 moves out of RIS beam 214 (e.g., to location 216), if care is not taken, BS 34 will be unable to transmit wireless signals 46 to UE device 10-3. In some implementations, RIS 50 may update the reflection coefficients of antenna elements 48 (e.g., re-forming RIS beam 214) to cover UE device 10-3 at location 216 or another RIS 50 may be selected to serve UE device 10-3 at location 216. However, both of these implementations are not efficient due to the extra signaling and latency required to control the RIS and to update the reflection coefficients of antenna elements 48.

To mitigate these issues, RIS 50 may leverage beam squint to continue to reflect wireless signals 46 from BS 34 to UE device 10-3 at location 216. This may, for example, allow RIS 50 to be able to continue to reflect wireless signals 46 to UE device 10-3 at location 216 with less delay than when the impedance settings of its antenna elements are updated and/or may allow RIS 50 to continue to reflect wireless signals 46 to UE devices 10-1 and 10-2 while concurrently reflecting wireless signals 46 to UE device 10-3 at location 216 (e.g., without updating the impedance settings of its antenna elements 48), while also maximizing efficiency and limiting signaling overhead.

This example is illustrative and non-limiting. If desired, RIS 50 may be omitted from communications system 8 and BS 34 may transmit wireless signals 46 directly to the UE devices. Portion 213 of FIG. 19 illustrates an example in which BS 34 transmits wireless signals 46 to UE devices 10-1, 10-2, and 10-3 without reflection off RIS 50. BS 34 may transmit wireless signals 46 over a BS beam 212 oriented towards UE devices 10-1, 10-2, and 10-3. The wireless signals 46 transmitted by BS 34 and thus BS beam 212 have a corresponding AOD. The AOD may be characterized by a corresponding elevation angle θ and a corresponding azimuthal angle ϕ. BS beam 212 may have beam width δ.

When a UE device such as UE device 10-3 moves out of BS beam 212 (e.g., to location 216), if care is not taken, BS 34 will be unable to transmit wireless signals 46 to UE device 10-3 without updating the phase and magnitude controllers 92 of its phased antenna array 88 (FIG. 5) (e.g., without re-forming BS beam 212). In some implementations, BS 34 may update the phase and magnitude settings of its phased antenna array (e.g., adjusting beamforming weights, thereby re-forming BS beam 212) to cover UE device 10-3 at location 216. However, this can reduce beamforming gain due to widened bandwidth and/or may be inefficient from a CSI report perspective, as previous CSI reports are based on the BS analog beam prior to UE device 10-3 moving to location 216. In other implementations, BS 34 may elect not to serve UE device 10-3 after it has moved to location 216 (e.g., another BS may use another beam to serve UE device 10-3 at location 216). However, this can potentially reduce system throughput and is also inefficient from a CSI report perspective.

To mitigate these issues, BS 34 may leverage beam squint to continue to transmit wireless signals 46 to UE device 10-3 at location 216. This may, for example, allow BS 34 to be able to continue to transmit wireless signals 46 to UE device 10-3 at location 216 with less delay than when the phase and magnitude settings of its phased antenna array are updated and/or may allow BS 34 to continue to transmit wireless signals 46 to UE devices 10-1 and 10-2 while concurrently transmitting wireless signals 46 to UE device 10-3 at location 216 (e.g., without updating the phase and magnitude settings of its phased antenna array), while also maximizing efficiency and limiting signaling overhead.

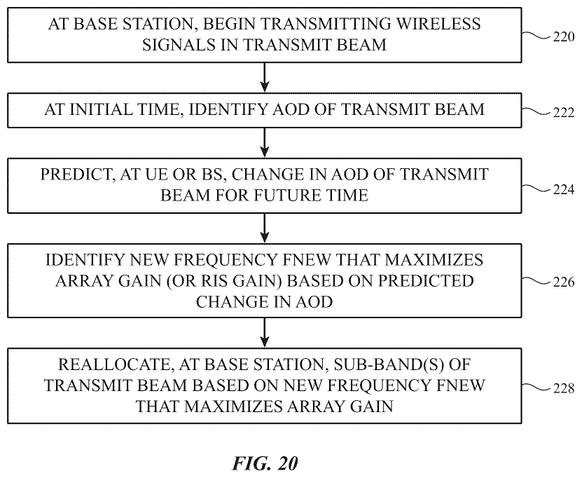

FIG. 20 is a flow chart of illustrative operations involved in leveraging beam squint to maintain communications between BS 34 and a UE device 10 (e.g., UE device 10-3 of FIG. 19) as the UE device moves over time. The operations of FIG. 20 are described in connection with a transmit beam used to transmit wireless signals 46 in the downlink direction from BS 34 to UE device 10 for the sake of clarity and simplicity. Similar operations may equivalently be used for the transmission of wireless signals 46 in the uplink transmission from UE device 10 to BS 34.

The transmit beam of wireless signals 46 may be BS beam 212 as shown in portion 213 of FIG. 19 (e.g., when wireless signals 46 are transmitted from BS 34 to UE device 10 without reflection off RIS 50) or may equivalently be RIS beam 214 shown in portion 211 of FIG. 19 (e.g., when wireless signals 46 are transmitted from BS 34 to UE device 10 via reflection off RIS 50). While referred to herein as a “transmit” beam for the sake of simplicity, the term “transmit” simply refers to the fact that the beam is used to transmit wireless signals in the DL direction. When RIS beam 214 forms the transmit beam, the transmit beam does not involve active transmission of wireless signals 46 by RIS 50 (e.g., because RIS 50 is a passive device) but instead involves the reflection, by RIS 50, of wireless signals 46 transmitted by BS 34.

At operation 220, BS 34 may begin transmitting wireless signals 46 using a corresponding transmit beam oriented towards an initial location of UE device 10. The transmit beam may be BS beam 212 when not reflecting the wireless signals off RIS 50 or may be RIS beam 214 when reflecting the wireless signals off RIS 50.

At operation 222, at an initial time, BS 34 may identify the angle-of-departure of the transmit beam (e.g., angles θ and ϕ of the AOD of BS 34 when the transmit beam is BS beam 212 or angles θd and ϕd of the RIS AOD Ar when the transmit beam is RIS beam 214). When the transmit beam is RIS beam 214, BS 34 may also identify the RIS AOA Ai of wireless signals 46 as incident upon RIS 50 (e.g., angles θa and ϕa). When the transmit beam is BS beam 34 (without deployment of RIS 50), BS 34 may identify its own AOD based on the phase and magnitude settings of the phase and magnitude controllers 92 coupled to its phased antenna array 88 (e.g., the beam forming weights of its phased antenna array).

On the other hand, when the transmit beam is RIS beam 214, BS 34 may identify RIS AOA Ai based on the orientation of BS beam 212, which points towards RIS 50, and/or the location of BS 34 and/or RIS 50. BS 34 may identify the orientation of BS beam 212, the location of RIS 50, and the location of BS 34 during an initial deployment, setup, and/or beam selection procedure, as examples. BS 34 may identify RIS AOD Ar based on the reflection coefficient settings of the antenna elements 48 on RIS 50 (e.g., the setting of adjustable devices 74 of FIG. 3). BS 34 may identify these settings using control RAT 60 (FIG. 2) and/or may already have knowledge of these settings in implementations where BS 34 controls, sets, or configures the reflection coefficients of the antenna elements 48 on RIS 50.

At operation 224, BS 34 and/or UE device 10 may predict (e.g., compute, estimate, calculate, generate, etc.), for a future time, a change in the AOD of the transmit beam required for the transmit beam to overlap a new location of the UE device after the UE device has physically moved relative to BS 34 (e.g., to location 216 in FIG. 19). When not reflecting the wireless signals off RIS 50, the change in AOD of the transmit beam may include a change in elevation angle Δθ and/or a change in azimuth angle Δϕ of BS beam 212. When reflecting the wireless signals off RIS 50, the change in AOD of the transmit beam may include a change in elevation angle Δθd and/or a change in azimuth angle Δϕd of the corresponding RIS AOD Ar.

At operation 226, BS 34 and/or UE device 10 may identify (e.g., compute, calculate, estimate, generate, determine, etc.), based on the predicted change in the AOD of the transmit beam, a new (updated) frequency FNEW for the transmitted wireless signals 46 that optimizes array gain given the beam squint of the array (e.g., the array gain of BS 34 or RIS 50). New frequency FNEW may, for example, optimize the array gain without requiring an adjustment to the phase and magnitude settings (or RIS reflection coefficient settings) used to form the transmit beam.

At operation 228, BS 34 may reallocate the frequency resources of the transmit beam based on frequency FNEW (e.g., may begin transmitting wireless signals 46 using frequency FNEW as the center carrier frequency instead of an initial frequency). This may, for example, involve reallocation of one or more sub-bands of the transmitted wireless signals 46. When transmitted at frequency FNEW, beam squint of the array may cause the transmitted wireless signals 46 to exhibit boosted gain at the new location of the UE device (e.g., at location 216 for UE device 10-3 of FIG. 19). Equivalently, when transmitted at frequency FNEW, beam squint causes the transmit beam to exhibit boosted (optimal) gain at an AOD given by the sum of the AOD of the transmit beam at the initial time (e.g., as identified at operation 222) with the predicted change in the AOD (e.g., as identified at operation 224).

For example, when RIS beam 214 forms the transmit beam, frequency FNEW may configure the RIS beam to exhibit optimal gain at a RIS AOD Ar having an evaluated elevation angle θd′ (where θd′=θd+Δθd) and having an evaluated azimuth elevation angle ϕd′ (where ϕd′=ϕd+Δϕd). On the other hand, when BS beam 212 forms the transmit beam, frequency FNEW configures the BS beam to exhibit optimal gain at an AOD having an evaluated elevation angle θ′ (where θ′=θ+Δθ) and an evaluated azimuth elevation angle ϕ (where ϕ′=ϕ+Δϕ). This may thereby allow for maintenance of the wireless link between BS 34 and UE device 10 despite the movement of UE device 10 and without requiring an adjustment to the reflection coefficients of RIS 50 or the phase and magnitude settings of BS 34.

In implementations where the transmit beam is formed by RIS beam 214, frequency FNEW may, for example, be calculated as the frequency f that maximizes the function |h(f)| (i.e., FNEW=arg (max_{f}|h(f)|)). Function |h(f)| is given defined equation 1 in a simple example where the antenna elements 48 in RIS 50 are arranged in a UPA and separated by uniform distance D. In general, function |h(f)| and equation 1 may be modified for any desired array geometry.

$$\vert h ( f ) \vert = \vert γ \vert \cdot \vert \frac{sin ( π M {β}_{y} )}{sin ( {πβ}_{y} )} \vert \cdot \vert \frac{sin ( π Q {β}_{Z} )}{sin ( {πβ}_{Z} )} \vert \qquad ( 1 )$$

In equation 1, γ represents the path loss due to both the hop from BS 34 to RIS 50 and the hop from BS 34 to UE device 10 combined with the antenna responses for arrival and departure directions and re-radiation efficiency, M is the number of columns of antenna elements 48 (e.g., along a first axis or dimension of the UPA), Q is the number of rows of antenna elements 48 (e.g., along a second axis or dimension of the UPA), β_{y} is defined by equation 2, and β_{z} is defined by equation 3.

$${β}_{y} = \frac{f D}{c} \cdot [ ( sin ( {θ}_{d}^{′} ) \cdot sin ( {ϕ}_{d}^{′} ) - sin ( {θ}_{a} ) \cdot sin ( ϕ ) ) - \frac{{f}_{c}}{f} ( sin ( {θ}_{d} ) \cdot sin ( {ϕ}_{d} ) - sin ( {θ}_{a} ) \cdot sin ( {ϕ}_{a} ) ) ] \qquad ( 2 )$$

$${β}_{z} = \frac{f D}{c} \cdot [ ( cos ( {θ}_{d}^{′} ) - cos ( {θ}_{a} ) ) - \frac{{f}_{c}}{f} ( cos ( {θ}_{d} ) - cos ( {θ}_{a} ) ) ] \qquad ( 3 )$$

On the other hand, in implementations where the transmit beam is formed by BS beam 212, frequency FNEW may be calculated as the frequency f that maximizes the function |h(f)| as defined by equation 4, in a simple case where the antennas in BS 34 (e.g., antennas 44 of FIG. 1 or antennas 86 in FIG. 5) are arranged in a UPA. In general, function |h(f)| and equation 4 may be modified for any desired array geometry.

$$\vert h ( f ) \vert = \vert γ \vert \cdot \sqrt{{N}_{x} {N}_{z}} \cdot \vert \frac{sin ( π {N}_{x} Δ x / 2 )}{{N}_{x} sin ( πΔ x / 2 )} \vert \cdot \vert \frac{sin ( π {N}_{z} Δ z / 2 )}{{N}_{z} sin ( πΔ z / 2 )} \vert \qquad ( 4 )$$

In equation 4, γ represents the path loss between BS 34 and UE device 10 combined with the antenna responses for arrival and departure directions, Nₓ is the number of columns of antenna in the array (e.g., along a first axis of the UPA), N_{z} is the number of rows of antenna in the array (e.g., along a second axis of the UPA), Δx is defined by equation 5, and Δz is defined by equation 6.

$$Δ x = cos ( ϕ ) sin ( θ ) - \frac{f}{{f}_{c}} cos ( {ϕ}^{′} ) sin ( {θ}^{′} ) \qquad ( 5 )$$

$$Δ z = cos ( θ ) - \frac{f}{{f}_{c}} cos ( {θ}^{′} ) \qquad ( 6 )$$

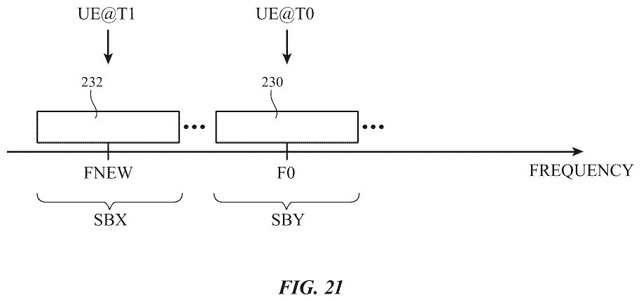

FIG. 21 is a frequency diagram showing how BS 34 may reallocate sub-bands of wireless signals 46 to frequency FNEW to maximize array gain given the new location of UE device 10 (e.g., while processing operation 228 of FIG. 20). As shown by block 230 of FIG. 21, when UE device 10 is at a first location at initial time TO, BS 34 may transmit wireless signals 46 to the UE device at frequency F0 of sub-band SBY using the transmit beam (e.g., via reflection off RIS 50 or without reflection off RIS 50). After UE device 10 has moved to a different location at time T1 (e.g., location 216 of FIG. 19), BS 34 may switch to transmitting wireless signals 46 to the UE device at frequency FNEW, which may belong to a different sub-band such as sub-band SBX. Transmission in sub-band SBX may cause the wireless signals to exhibit optimal gain at the new location of UE device 10 at time T1 due to beam squint.

If desired, BS 34 may determine whether or not to re-allocate sub-bands to UE device 10 based on the identified frequency FNEW that would maximize array gain at the new location of UE device 10 (e.g., while processing operation 228). As a part of this determination, BS 34 may compare the identified frequency FNEW to the currently allocated sub-band SBY having center frequency F0 as well as the corresponding bandwidth BW_{SB} of sub-band SBY. In one example, BS 34 may allocate an updated sub-band to UE device 10 (e.g., may adjust the frequency of the transmitted wireless signals 46) only if/when |FNEW−F0|>BW_{SB} and may forego reallocation when |FNEW−F0|≤BW_{SB} (e.g., when FNEW and F0 lie within the same sub-band SBY). In the example of FIG. 21, BS 34 would allocate sub-band SBX to UE device 10 (e.g., switching to transmission of wireless signals 46 in sub-band SBX) because FNEW lies outside of the bandwidth BW_{SB} of sub-band SBY.

In another example, BS 34 may allocate an updated sub-band to UE device 10 only if/when |h (FNEW)|−|h (F0)|>TH, where TH is a predetermined threshold. Additionally or alternatively, BS 34 may adjust the total number of sub-bands SB allocated to UE device 10 for the transmission of wireless signals 46. In another example, if frequency FNEW is outside of the total bandwidth BW of wireless signals 46, BS 34 may allocate the sub-band SB at the edge of bandwidth BW to UE device 10. In implementations where wireless signals 46 are reflected off RIS 50, BS 34 may reconfigure the reflection coefficients of RIS 50 or may use a different RIS 50 to relay wireless signals 46 to UE device 10. In yet another example, the sub-band reallocation may also consider the beamwidth of the transmit beam (e.g., when beam width is larger, sub-band reallocation may be more conservative than when beam width is smaller).

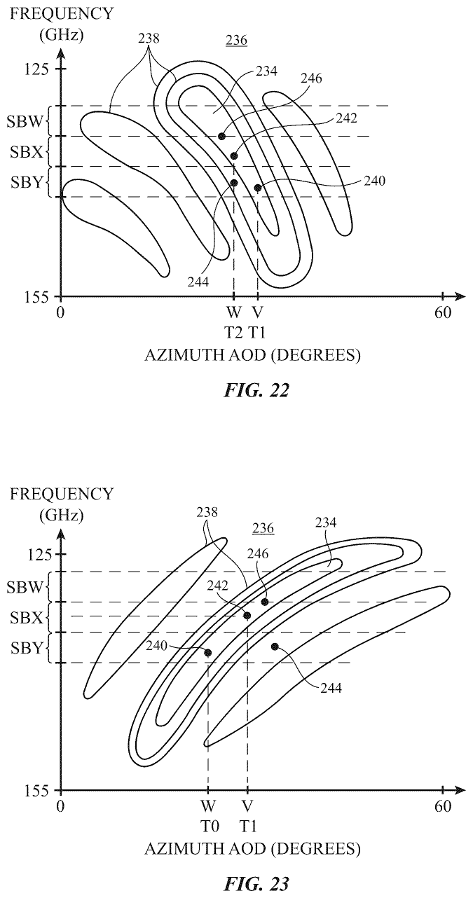

FIG. 22 is a plot of the variation in array gain of BS 34 over different frequencies and azimuth angles ϕ of the AOD of BS 34, showing how adjusting the frequency allocation of wireless signals 46 may maintain communications with a UE device that moves over time (e.g., in implementations without reflection off RIS 50). Curves 238 of FIG. 22 plot contours of constant array gain, from a region 236 of minimum array gain (sometimes referred to herein as minimum gain region 236) to a region 234 of maximum array gain (sometimes referred to herein as peak gain region 234). In practice, curves 238 of FIG. 22 may have other shapes. The plot of FIG. 22 may be generalized to a three-dimensional graph that also accounts for the elevation angles θ of the AOD of BS 34.

At an initial time T1, UE device 10 may be located at an AOD from BS 34 having azimuth angle ϕ=V. BS 34 may transmit wireless signals 46 in sub-band SBY to achieve peak array gain for UE device 10 at azimuth angle ϕ=V as shown by point 240, which lies within peak gain region 234. At a later time T2, UE device 10 may have moved to an AOD from BS 34 having azimuth angle ϕ=W. If BS 34 continues to transmit wireless signals 46 in sub-band SBY while UE device 10 is at azimuth angle ϕ=W, the BS will exhibit deteriorated array gain in communicating with UE device 10 as shown by point 244, which is located outside of peak gain region 234. This deterioration in array gain limits wireless performance of BS 34 and UE device 10. On the other hand, BS 34 may re-allocate UE device 10 to sub-band SBX when UE device 10 is at azimuth angle ϕ=W (e.g., while processing the operations of FIG. 20).

As shown by point 242, sub-band SBX overlaps peak gain region 234 when UE device 10 is at azimuth angle ϕ=W. As such, transmitting wireless signals 46 within sub-band SBX to UE device 10 at azimuth angle ϕ=W will maximize array gain and thus wireless performance of BS 34 and UE device 10. If desired, BS 34 may allocate multiple sub-bands to UE device 10 (e.g., may allocate both sub-bands SBX and SBW to UE device 10 when at an AOD corresponding to point 246). In this way, BS 34 may leverage beam squint to continue to serve UE device 10 after the UE device has moved and without adjusting the phase and magnitude settings of its array.

FIG. 23 is a plot of the variation in array gain of RIS 50 over different frequencies and azimuth angles ϕd of the RIS AOD Ar of RIS 50, showing how adjusting the frequency allocation of wireless signals 46 may maintain communications with a UE device that moves over time (e.g., in implementations that include reflection off RIS 50). Curves 238 of FIG. 23 plot contours of constant RIS array gain, from minimum gain region 236 to maximum gain region 234. In practice, curves 238 of FIG. 23 may have other shapes. The plot of FIG. 23 may be generalized to a three-dimensional graph that also accounts for the elevation angles θd of the RIS AOD Ar of RIS 50.

At an initial time TO, UE device 10 may be located at a RIS AOD Ar having azimuth angle ϕd=W (e.g., any arbitrary azimuth angle and not necessarily the same azimuth angle W as in FIG. 22). BS 34 may transmit wireless signals 46 in sub-band SBY to achieve peak RIS array gain for UE device 10 at azimuth angle ϕd=W as shown by point 240 of FIG. 23, which lies within peak gain region 234.

At a later time T1 (e.g., any arbitrary time after time T0 and not necessarily the same time T1 as in FIG. 22), UE device 10 may have moved to a RIS AOD Ar having azimuth angle ϕd=V (e.g., any arbitrary azimuth angle and not necessarily the same azimuth angle V as in FIG. 22). If BS 34 continues to transmit wireless signals 46 in sub-band SBY while UE device 10 is at azimuth angle ϕd=V, the RIS will exhibit deteriorated RIS array gain in communicating with UE device 10 as shown by point 244 of FIG. 23, which is located outside of peak gain region 234. This deterioration in RIS array gain limits wireless performance of BS 34, RIS 50, and UE device 10. On the other hand, BS 34 may re-allocate UE device 10 to sub-band SBX when UE device 10 is at azimuth angle ϕd=V (e.g., while processing the operations of FIG. 20).

As shown by point 242 of FIG. 23, sub-band SBX overlaps peak gain region 234 when UE device 10 is at azimuth angle ϕd=V. As such, transmitting wireless signals 46 within sub-band SBX to UE device 10 at azimuth angle ϕd=V will maximize RIS array gain and thus wireless performance of BS 34, RIS 50, and UE device 10. If desired, BS 34 may allocate multiple sub-bands to UE device 10 (e.g., may allocate both sub-bands SBX and SBW to UE device 10 when at an AOD corresponding to point 246 of FIG. 23). In this way, BS 34 and RIS 50 may leverage beam squint to continue to serve UE device 10 after the UE device has moved and without adjusting the phase and magnitude settings of BS 34 or the reflection coefficient settings of RIS 50.

If desired, BS 34 may predict the change in AOD of the transmit beam (e.g., BS beam 212 or RIS beam 214 of FIG. 19) based on measurement reports received from UE device 10 (e.g., while processing operation 224 of FIG. 20). For example, UE device 10 may measure the wireless signals 46 transmitted by BS 34 and may generate wireless performance metric data from the wireless signals across different time-domain swept transmit beams and/or across different sub-bands. As one non-limiting example, the wireless performance metric data may include respective RSRP values measured by UE device 10 for different combinations of time-domain swept transmit beams (e.g., BS beams 212 or RIS beams 214 of FIG. 19) and/or sub-bands SB.

If desired, BS 34 may use an artificial intelligence (AI) or machine learning (ML) model to correlate RSRP values of different transmit beams and/or sub-bands to different AODs of the transmit beam (e.g., AODs of BS 34 or RIS AODs of RIS 50). As one example, RSRPs of different transmit beams and/or sub-bands and transmit beam and/or sub-band identities may be input to the AI/ML model and the AI/ML model may output the AOD of the transmit beam (e.g., the AOD of BS 34 or the RIS AOD of RIS 50). In another example, RSRP values of different transmit beams and/or sub-bands and transmit beam and/or sub-band identities across different times may be input to the AI/ML model and the AI/ML model may output the change in AOD (e.g., the change in AOD of BS 34 or the change in RIS AOD of RIS 50).

Consider an example in which UE device 10 moves from a first position at time T0 to a second position at time TO′, where the transmit beam is swept over three different AOD's during beam tracking, and the UE device measures and reports RSRP for the transmit beam overlapping the UE device as well two neighboring transmit beams. In this example, when the UE moves from the first position to the second position, RSRP measurements for the three transmit beams will also change. Based on the change in RSRP (e.g., as reported to BS 34 by UE device 10), BS 34 may estimate the change in AOD of the transmit beam from time T0 to time T0′ (e.g., using the AI/ML model).

If desired, BS 34 may store a map that correlates transmit beam AODs (e.g., AODs of BS beam 212 or RIS beam 214) to the RSRPs of different beams. In this way, BS 34 may directly read the map to obtain the transmit beam AOD via the reported RSRPs of different transmit beams. The AI/ML model may be used to generate the map, for example. BS 34 may further predict the change in the AOD of the transmit beam from time T0 or time T0′ to a future time T1 when BS 34 is going to schedule a subsequent transmission to the UE device.

In another example, UE device 10 may report RSRPs for different sub-bands to BS 34. BS 34 may determine the change in AOD of the transmit beam based on the change of sub-band RSRPs. For example, UE device 10 may report the RSRPs of adjacent or non-adjacent sub-bands SBX, SBY, and SBZ for times T0 and T0′. For time T0, sub-band SBY may have the highest RSRP whereas for time T0′, sub-band SBX may have the highest RSRP. Based on the change in sub-band RSRPs, BS 34 may estimate the change in AOD of the transmit beam from time T0 to time T0′. The change of frequency that yields the highest array gain (or RIS array gain) may imply a change in AOD, for example. If desired, BS 34 may further predict a change in the AOD of the transmit beam from time T0 or time T0′ to a future time T1 when BS 34 will schedule another transmission to UE device 10.

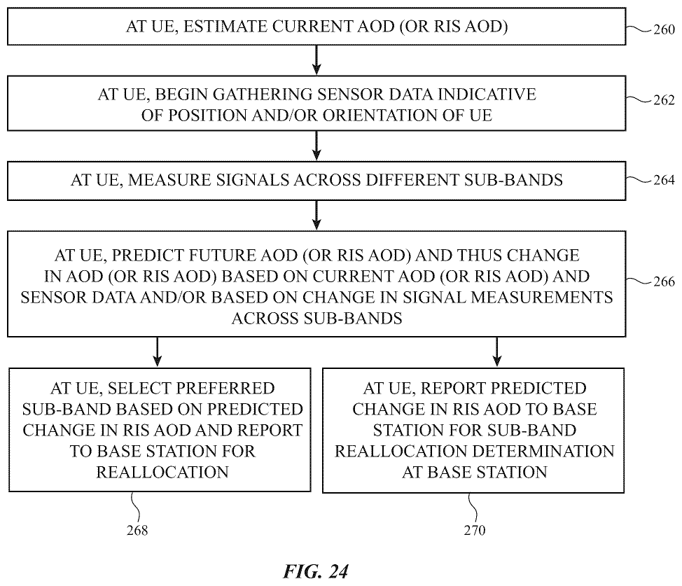

FIG. 24 is a flow chart of illustrative operations that may be performed by UE device 10 to predict the change in the AOD of the transmit beam, for use by BS 34 in re-allocating the sub-band(s) of transmit wireless signals 46. The operations of FIG. 24 may, for example, be performed by UE device 10 while processing operation 224 of FIG. 20.

At operation 260, UE device 10 may estimate the current AOD of the transmit beam oriented towards UE device 10 (sometimes referred to herein as AOD0). This may be the AOD of BS 34 when wireless signals 34 are not reflected off RIS 50 or may include the RIS AOD Ar of RIS 50 when wireless signals 34 are reflected off RIS 50.

At operation 262, UE device 10 may begin gathering sensor data indicative of the position and/or orientation of UE device 10 (e.g., accelerometer data, motion sensor data, compass data, gyroscope data, light sensor data, radio-frequency sensor data, satellite navigation receiver data, etc.). The sensor data may help to identify mobility patterns of UE device 10. Operation 262 may be performed concurrently with operation 260 if desired.

UE device 10 estimate AOD0 at operation 260 using local AOA estimation at UE device 10 (e.g., considering the local coordinate system), an estimation of the orientation of UE device 10 (e.g., based on the sensor data gathered at operation 262), and/or an estimation of the orientation of BS 34 and/or RIS 50, for example. In another example, when UE device 10 has knowledge of both its own location and the location of BS 34 and/or RIS 50 (e.g., from the initialization of communications), UE device 10 may calculate the AOD of the transmit beam directly using geometric/trigonometric functions (assuming ling-of-sight between UE device 10 and BS 34 or RIS 50).

If desired, at operation 264, UE device 10 may measure incident wireless signals 46 across different sub-bands SB. Operation 264 may be performed concurrently with operation 260 and/or operation 262 or may be omitted. For example, UE device 10 may gather RSRPs of sub-bands SBX, SBY, and SBZ before and after moving positions from time T0 to time T0′.

At operation 266, UE device 10 may predict a future AOD of the transmit beam (sometimes referred to herein as AOD1) and thus the expected future change in AOD of the transmit beam (e.g., AOD1-AOD0) based on the current AOD of the transmit beam AOD0, the gathered sensor data, and/or a change in signal measurements across sub-bands (e.g., as measured at operation 264). Operation 266 may be performed concurrently with one or more of operations 260-264 if desired. The change in AOD may be a change in the AOD of BS beam 212 when wireless signals 46 are not reflected off RIS 50 or may be a change in the RIS AOD Ar of RSI beam 214 when wireless signals 46 are reflected off RIS 50. As one example, UE device 10 may predict AOD1 and thus the change in AOD (e.g., AOD1-AOD0) based on the estimation of AOD0 and UE local context information about the movement and/or rotation of UE device 10 (e.g., the sensor data gathered while processing operation 264). For example, when the sensor data indicates that UE device 10 has moved a certain distance away from its previous location between times T0 and T0′, UE device 10 may use that distance, the initial AOD0, and the geometry of the system to estimate the new AOD1 needed to point towards its new location.

Additionally or alternatively, UE device 10 may estimate the rate of change of the AOD of the transmit beam based on measurements (e.g., RSRP values) across sub-bands. With the rate information, the UE device can predict the change in the AOD of the transmit beam at a future time. If desired, UE device 10 may use an AI/ML model to correlate RSRPs of different sub-bands to AOD information. In one example, RSRPs of different sub-bands and sub-band identities at different times may be input to the AI/ML model, which outputs the rate of change of the AOD of the transmit beam.

In sum, the UE may predict the change in AOD used by base station 34 to re-allocate sub-bands to wireless signals 46 by estimating its current AOD (AOD0) and predicting a future AOD (AOD1). The UE device may then predict the AOD change as AOD1-AOD0. Alternatively, the UE device may estimate the rate of change of the AOD based on different sub-band measurements. With the rate information, AOD change at a future time may be predicted. The AOD at the current time may need to be available to UE device 10 in this example. The AOD may either be signaled from BS 34 to UE device 10 or estimated at UE device 10. In either of these options, the UE device may use sensor data to help identify the AOD(s) and/or the changes in AOD(s).

In implementations where wireless signals 46 are reflected off RIS 50, after the UE has predicted the change in RIS AOD, processing may proceed either to operation 268 or to operation 270. At operation 268, UE device 10 may select its preferred sub-band for wireless signals 46 based on the predicted change in RIS AOD. UE device 10 may then report the preferred sub-band to BS 34. BS 34 may then use the preferred sub-band reported by UE device 10 to transmit wireless signals 46.

UE device 10 may report the preferred sub-band in any desired format. For example, UE device 10 may transmit an absolute sub-band index identifying the sub-band to BS 34. As another example, UE device 10 may transmit a differential sub-band index relative to the already-allocated sub-band to BS 34. For example, if the allocated sub-band at time T0 is sub-band SBX and the preferred sub-band at a future time T1 is sub-band Y, UE device 10 may transmit information to BS 34 identifying the difference between sub-bands (e.g., Y-X) to BS 34. This may, for example, involve less signaling overhead than transmitting absolute sub-band index. Sub-band reselection may be triggered by a motion sensor on UE device 10 measuring that UE device 10 has moved linearly (rather than rotating), as one example.

At alternative operation 270, UE device 10 may report the predicted change in RIS AOD to BS 34. BS 34 may then use the change in RIS AOD predicted by UE device 10 to generate its own sub-band reallocation for UE device 10. Note that, although the eventual sub-band reallocation is determined by BS 34, the preferred reallocated sub-band(s) can be predicted either by BS 34 or UE device 10.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 and/or external device 34 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-25 may be performed by the components of device 10, RIS 50, and/or external device 34 using software, firmware, and/or hardware (e.g., dedicated circuitry or hardware). Software code for performing these operations may be stored on non-transitory computer readable storage media (e.g., tangible computer readable storage media) stored on one or more of the components of device 10, RIS 50, and/or external device 34. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10, RIS 50, and/or external device 34. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth in the example section below. For example, circuitry associated with an electronic device, authentication server, one or more processors, etc. as described above in connection with one or more of the preceding figures may be configured to operate in accordance with one or more of the examples set forth below in the example section.

### EXAMPLES

In the following sections, further exemplary aspects are provided.

Example 1 includes an electronic device comprising: a phased antenna array configured to transmit wireless signals using a phase and magnitude setting that configures the phased antenna array to form a signal beam of the wireless signals; and one or more processors configured to adjust, based on a beam squint of the signal beam, the wireless signals transmitted by the phased antenna array.

Example 2 includes the electronic device of example 1 or some other example or combination of examples herein, the one or more processors being configured to adjust, based on the beam squint, the wireless signals transmitted by the phased antenna array without changing the phase and magnitude setting.

Example 3 includes the electronic device of any one of examples 1 or 2 or some other example or combination of examples herein, the one or more processors being configured to adjust a modulation coding scheme (MCS) of the wireless signals based on the beam squint of the signal beam.

Example 4 includes the electronic device of any one of examples 1-3 or some other example or combination of examples herein, the one or more processors being configured to adjust a transmit power level of the wireless signals based on the beam squint of the signal beam.

Example 5 includes the electronic device of any one of examples 1-4 or some other example or combination of examples herein, the one or more processors being configured to adjust a reference signal density of the wireless signals based on the beam squint of the signal beam.

Example 6 includes the electronic device of any one of examples 1-5 or some other example or combination of examples herein, the one or more processors being configured to adjust a width of the signal beam based on the beam squint of the signal beam.

Example 7 includes the electronic device of any one of examples 1-6 or some other example or combination of examples herein, the one or more processors being configured to adjust a frequency resource allocation of the wireless signals based on the beam squint of the signal beam.

Example 8 includes the electronic device of any one of examples 1-7 or some other example or combination of examples herein, the one or more processors being configured to perform carrier aggregation band selection for the wireless signals based on the beam squint of the signal beam.

Example 9 includes the electronic device of any one of examples 1-8 or some other example or combination of examples herein, the one or more processors being configured to perform a beam selection procedure based on the beam squint of the signal beam.

Example 10 includes the electronic device of any one of examples 1-9 or some other example or combination of examples herein, wherein the phased antenna array is configured to transmit, to an external device, beam information that identifies an adjustment made to the wireless signals based on the beam squint of the signal beam.

Example 11 includes a method of operating an electronic device, the method comprising: forming, using phase and magnitude controllers of a phased antenna array, a signal beam while the phase and magnitude controllers exhibit a phase and magnitude setting; transmitting, using a transmitter coupled to the phased antenna array, wireless signals over the signal beam while the phase and magnitude controllers exhibit the phase and magnitude setting; and adjusting, using the transmitter, the wireless signals based on a beam squint of the signal beam.

Example 12 includes the method of example 11 or some other example or combination of examples herein, wherein the wireless signals have a bandwidth and the method further comprises: transmitting, while the phase and magnitude controllers exhibit the phase and magnitude setting, the wireless signals using a first modulation coding scheme (MCS) in a first sub-band of the bandwidth, the first sub-band overlapping a center frequency of the bandwidth; transmitting, concurrent with transmission of the wireless signals using the first MCS in the first sub-band, the wireless signals using a second MCS in a second sub-band of the bandwidth, the second MCS being lower order than the first MCS; and transmitting, using the transmitter, a signal that identifies the first MCS and the second MCS.

Example 13 includes the method of any one of examples 11 or 12 or some other example or combination of examples herein, wherein the wireless signals have a bandwidth and the method further comprises: transmitting, while the phase and magnitude controllers exhibit the phase and magnitude setting, the wireless signals using a first transmit power level in a first sub-band of the bandwidth; transmitting, concurrent with transmission of the wireless signals using the first transmit power level in the first sub-band, the wireless signals using a second transmit power level in a second sub-band of the bandwidth, the second transmit power level being different from the first transmit power level; and transmitting, using the transmitter, a signal that identifies the first transmit power level and the second transmit power level.

Example 14 includes the method of any one of examples 11-13 or some other example or combination of examples herein, wherein the wireless signals have a bandwidth and the method further comprises: transmitting, while the phase and magnitude controllers exhibit the phase and magnitude setting, the wireless signals using a first reference signal density in a first sub-band of the bandwidth, the first sub-band overlapping a center frequency of the bandwidth; transmitting, concurrent with transmission of the wireless signals using the first reference signal density in the first sub-band, the wireless signals using a second reference signal density in a second sub-band of the bandwidth, the second reference signal density being greater than the first reference signal density; and transmitting, using the transmitter, a signal that identifies the first reference signal density and the second reference signal density.

Example 15 includes the method of any one of examples 11-14 or some other example or combination of examples herein, wherein the signal beam has a first angle-of-departure (AOD), the method further comprising: forming, using the phase and magnitude controllers, an additional signal beam while the phase and magnitude controllers exhibit an additional phase and magnitude setting, the additional signal beam having a second AOD greater than the first AOD; and transmitting, using the transmitter, additional wireless signals over the additional signal beam while the phase and magnitude controllers exhibit the additional phase and magnitude setting, wherein transmitting the wireless signals over the signal beam includes transmitting the wireless signals using a primary component carrier (PCC) and a secondary component carrier (SCC), and transmitting the additional wireless signals over the additional signal beam includes transmitting the wireless signals using the PCC.

Example 16 includes the method of any one of examples 11-15 or some other example or combination of examples herein, wherein transmitting the additional wireless signals comprises transmitting the additional wireless signals using an additional SCC, the PCC being closer to the additional SCC than to the SCC.

Example 17 includes the method of any one of examples 11-16 or some other example or combination of examples herein, wherein the signal beam has a first angle-of-departure (AOD) and a first beam width, the method further comprising: forming, using the phase and magnitude controllers, an additional signal beam while the phase and magnitude controllers exhibit an additional phase and magnitude setting, the additional signal beam having a second AOD greater than the first AOD; and transmitting, using the transmitter, additional wireless signals over the additional signal beam while the phase and magnitude controllers exhibit the additional phase and magnitude setting, wherein the additional signal beam has a second beam width greater than the first beam width.

Example 18 includes a method of operating an electronic device, the method comprising: forming, using phase and magnitude controllers of a phased antenna array, a receive beam while the phase and magnitude controllers exhibit a phase and magnitude setting; performing, using a receiver coupled to the phased antenna array, a first measurement of a first sub-band of reference signals transmitted by an external device while the phase and magnitude controllers exhibit the phase and magnitude setting; performing, using the receiver, a second measurement of a second sub-band of the reference signals while the phase and magnitude controllers exhibit the phase and magnitude setting; and transmitting, to the external device, a measurement report associated with the first measurement and the second measurement.

Example 19 includes the method of example 18 or some other example or combination of examples herein, further comprising: receiving, using the phased antenna array, the first sub-band of the reference signals while the external device transmits the reference signals using a first transmit beam, the first measurement being performed on the reference signals transmitted using the first transmit beam; and receiving, using the phased antenna array, the second sub-band of the reference signals while the external device transmits the reference signals using the first transmit beam, the second measurement being performed on the reference signals transmitted using the first transmit beam.

Example 20 includes the method of any one of example 18 or 19 or some other example or combination of examples herein, further comprising: forming, using the phase and magnitude controllers, an additional receive beam while the phase and magnitude controllers exhibit an additional phase and magnitude setting; receiving, using the phased antenna array, additional reference signals transmitted by the external device using a second transmit beam different from the first transmit beam; performing, using the receiver, a third measurement of the first sub-band of the additional reference signals while the phase and magnitude controllers exhibit the additional the phase and magnitude setting; and performing, using the receiver, a fourth measurement of the second sub-band of the additional reference while the phase and magnitude controllers exhibit the additional phase and magnitude setting.

Example 21 includes a method of operating a first electronic device to communicate with a second electronic device, the method comprising: transmitting, using a phased antenna array while configured using phase and magnitude settings, first wireless signals to the second electronic device at a first location, the first wireless signals being transmitted at a first frequency; and transmitting, using the phased antenna array while configured using the phase and magnitude settings, second wireless signals to the second electronic device at a second location, the second wireless signals being transmitted at a second frequency different from the first frequency and the second location being different from the first location.

Example 22 includes the method of example 21 or some other example or combination of examples herein, wherein the phase and magnitude settings configure the phased antenna array to form a signal beam oriented towards a reconfigurable intelligent surface (RIS) that reflects the first wireless signals towards the first location while antenna elements on the RIS exhibit a set of reflection coefficients.

Example 23 includes the method of any one of examples 21 or 22 or some other example or combination of examples herein, wherein the RIS reflects the second wireless signals towards the second location while the antenna elements on the RIS exhibit the set of reflection coefficients.

Example 24 includes the method of any one of examples 21-23 or some other example or combination of examples herein, wherein the first electronic device is a wireless base station and the second electronic device is a user equipment device.

Example 25 includes the method of any one of examples 21-24 or some other example or combination of examples herein, wherein the first electronic device is a user equipment device and the second electronic device is a wireless base station.

Example 26 includes the method of any one of examples 21-25 or some other example or combination of examples herein, wherein transmitting the first wireless signals comprises transmitting the first wireless signals to the second electronic device without reflection off a reconfigurable intelligent surface (RIS).

Example 27 includes the method of any one of examples 21-26 or some other example or combination of examples herein, wherein the first electronic device is a wireless base station and the second electronic device is a user equipment device.

Example 28 includes the method of any one of examples 21-27 or some other example or combination of examples herein, wherein the first electronic device is a user equipment device and the second electronic device is a wireless base station.

Example 29 includes the method of any one of examples 21-28 or some other example or combination of examples herein, further comprising: identifying, using one or more processors, the second frequency based on a first angle from the first electronic device to the first location and a second angle from the first electronic device to the second location.

Example 30 includes the method of any one of examples 21-29 or some other example or combination of examples herein, wherein identifying the second frequency comprises identifying a frequency that optimizes a gain of the phased antenna array at the second location without changing the phase and magnitude settings of the phased antenna array.

Example 31 includes the method of any one of examples 21-30 or some other example or combination of examples herein, wherein the first frequency is within a first sub-band having a sub-band bandwidth and the second frequency is within a second sub-band outside the sub-band bandwidth.

Example 32 includes the method of any one of examples 21-31 or some other example or combination of examples herein, wherein identifying the second frequency comprises identifying the second frequency based on wireless performance metric data received from the second electronic device, the wireless performance metric data being measured by the second electronic device based on the first wireless signals.

Example 33 includes the method of any one of examples 21-32 or some other example or combination of examples herein, wherein identifying the second frequency comprises identifying the second frequency based on a machine learning model.

Example 34 includes the method of any one of examples 21-33 or some other example or combination of examples herein, further comprising: identifying, using one or more processors, the second frequency based on a message received from the second electronic device.

Example 35 includes the method of any one of examples 21-34 or some other example or combination of examples herein, wherein the first wireless signals are transmitted in a first sub-band and the second wireless signals are transmitted in a second sub-band different from the first sub-band and in a third sub-band different from the first sub-band and the second sub-band.

Example 36 includes a method of operating a reconfigurable intelligent surface (RIS) to reflect communications between a first electronic device and a second electronic device, the method comprising: reflecting, using an array of antenna elements while configured to exhibit a set of reflection coefficients, a first wireless signal towards the second electronic device at a first location, the first wireless signal being transmitted by the first electronic device in a first sub-band using phase and magnitude settings; and reflecting, using the array of antenna elements while configured to exhibit the set of reflection coefficients, a second wireless signal towards the second electronic device at a second location different from the first location, the second wireless signal being transmitted by the first electronic device in a second sub-band using the phase and magnitude settings, and the second sub-band being different from the first sub-band.

Example 37 includes a method of operating a user equipment (UE) device to communicate with a wireless base station, the method comprising: receiving, using a phased antenna array while the UE device is at a first location, first wireless signals transmitted by the wireless base station while the wireless base station is configured using phase and magnitude settings, the first wireless signals being in a first sub-band; and receiving, using the phased antenna array while the UE device is at a second location different from the first location, second wireless signals transmitted by the wireless base station while the wireless base station is configured using the phase and magnitude settings, the second wireless signals being in a second sub-band different from the first sub-band.

Example 38 includes the method of example 37 or some other example or combination of examples herein, further comprising: identifying, using one or more processors, a first angle from the wireless base station to the first location; generating, using one or more sensors, sensor data associated with the UE device moving from the first location to the second location; identifying, using the one or more processors, a second angle from the wireless base station to the second location based on the sensor data; and transmitting, using a transmitter, a report to the wireless base station associated with the first angle and the second angle.

Example 39 includes the method of any one of examples 37 or 38 or some other example or combination of examples herein, further comprising: performing, using a receiver, measurements of the first wireless signals across multiple sub-bands; and identifying, using the one or more processors, the second angle based on the measurements across the multiple sub-bands.

Example 40 includes the method of any one of examples 37-39 or some other example or combination of examples herein, wherein the report identifies the second sub-band.

Example 41 may include an apparatus comprising means to perform one or more elements of a method described in or related to any of examples 1-40 or any combination thereof, or any other method or process described herein.

Example 42 may include one or more non-transitory computer-readable media comprising instructions to cause an electronic device, upon execution of the instructions by one or more processors of the electronic device, to perform one or more elements of a method described in or related to any of examples 1-40 or any combination thereof, or any other method or process described herein.

Example 43 may include an apparatus comprising logic, modules, or circuitry to perform one or more elements of a method described in or related to any of examples 1-40 or any combination thereof, or any other method or process described herein.

Example 44 may include a method, technique, or process as described in or related to any of examples 1-40 or any combination thereof, or portions or parts thereof.

Example 45 may include an apparatus comprising: one or more processors and one or more non-transitory computer-readable storage media comprising instructions that, when executed by the one or more processors, cause the one or more processors to perform the method, techniques, or process as described in or related to any of examples 1-40, or any combination thereof, or portions thereof.

Example 46 may include a signal as described in or related to any of examples 1-40, or any combination thereof, or portions or parts thereof.

Example 47 may include a datagram, information element, packet, frame, segment, PDU, or message as described in or related to any of examples 1-40, or any combination thereof, or portions or parts thereof, or otherwise described in the present disclosure.

Example 47 may include a signal encoded with data as described in or related to any of examples 1-40, or any combination thereof, or portions or parts thereof, or otherwise described in the present disclosure.

Example 48 may include a signal encoded with a datagram, IE, packet, frame, segment, PDU, or message as described in or related to any of examples 1-40, or any combination thereof, or portions or parts thereof, or otherwise described in the present disclosure.

Example 49 may include an electromagnetic signal carrying computer-readable instructions, wherein execution of the computer-readable instructions by one or more processors is to cause the one or more processors to perform the method, techniques, or process as described in or related to any of examples 1-40, or any combination thereof, or portions thereof.

Example 50 may include a computer program comprising instructions, wherein execution of the program by a processing element is to cause the processing element to carry out the method, techniques, or process as described in or related to any of examples 1-40, or any combination thereof, or portions thereof.

Example 51 may include a signal in a wireless network as shown and described herein.

Example 52 may include a method of communicating in a wireless network as shown and described herein.

Example 53 may include a system for providing wireless communication as shown and described herein.

Example 54 may include a device for providing wireless communication as shown and described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

What is claimed is:

1. An electronic device comprising:
a phased antenna array configured to transmit wireless signals using a phase and magnitude setting that configures the phased antenna array to form a signal beam of the wireless signals; and
one or more processors configured to adjust, based on a beam squint of the signal beam, the wireless signals transmitted by the phased antenna array.

2. The electronic device of claim 1, the one or more processors being configured to adjust, based on the beam squint, the wireless signals transmitted by the phased antenna array without changing the phase and magnitude setting.

3. The electronic device of claim 1, the one or more processors being configured to adjust a modulation coding scheme (MCS) of the wireless signals based on the beam squint of the signal beam.

4. The electronic device of claim 1, the one or more processors being configured to adjust a transmit power level of the wireless signals based on the beam squint of the signal beam.

5. The electronic device of claim 1, the one or more processors being configured to adjust a reference signal density of the wireless signals based on the beam squint of the signal beam.

6. The electronic device of claim 1, the one or more processors being configured to adjust a width of the signal beam based on the beam squint of the signal beam.

7. The electronic device of claim 1, the one or more processors being configured to adjust a frequency resource allocation of the wireless signals based on the beam squint of the signal beam.

8. The electronic device of claim 1, the one or more processors being configured to perform carrier aggregation band selection for the wireless signals based on the beam squint of the signal beam.

9. The electronic device of claim 1, the one or more processors being configured to perform a beam selection procedure based on the beam squint of the signal beam.

10. The electronic device of claim 1, wherein the phased antenna array is configured to transmit, to an external device, beam information that identifies an adjustment made to the wireless signals based on the beam squint of the signal beam.

11. A method of operating an electronic device, the method comprising:
forming, using phase and magnitude controllers of a phased antenna array, a signal beam while the phase and magnitude controllers exhibit a phase and magnitude setting;
transmitting, using a transmitter coupled to the phased antenna array, wireless signals over the signal beam while the phase and magnitude controllers exhibit the phase and magnitude setting; and
adjusting, using the transmitter, the wireless signals based on a beam squint of the signal beam.

12. The method of claim 11, wherein the wireless signals have a bandwidth and the method further comprises:
transmitting, while the phase and magnitude controllers exhibit the phase and magnitude setting, the wireless signals using a first modulation coding scheme (MCS) in a first sub-band of the bandwidth, the first sub-band overlapping a center frequency of the bandwidth; and
transmitting, concurrent with transmission of the wireless signals using the first MCS in the first sub-band, the wireless signals using a second MCS in a second sub-band of the bandwidth, the second MCS being lower order than the first MCS; and
transmitting, using the transmitter, a signal that identifies the first MCS and the second MCS.

13. The method of claim 11, wherein the wireless signals have a bandwidth and the method further comprises:
transmitting, while the phase and magnitude controllers exhibit the phase and magnitude setting, the wireless signals using a first transmit power level in a first sub-band of the bandwidth;
transmitting, concurrent with transmission of the wireless signals using the first transmit power level in the first sub-band, the wireless signals using a second transmit power level in a second sub-band of the bandwidth, the second transmit power level being different from the first transmit power level; and
transmitting, using the transmitter, a signal that identifies the first transmit power level and the second transmit power level.

14. The method of claim 11, wherein the wireless signals have a bandwidth and the method further comprises:
transmitting, while the phase and magnitude controllers exhibit the phase and magnitude setting, the wireless signals using a first reference signal density in a first sub-band of the bandwidth, the first sub-band overlapping a center frequency of the bandwidth;
transmitting, concurrent with transmission of the wireless signals using the first reference signal density in the first sub-band, the wireless signals using a second reference signal density in a second sub-band of the bandwidth, the second reference signal density being greater than the first reference signal density; and
transmitting, using the transmitter, a signal that identifies the first reference signal density and the second reference signal density.

15. The method of claim 11, wherein the signal beam has a first angle-of-departure (AOD), the method further comprising:
forming, using the phase and magnitude controllers, an additional signal beam while the phase and magnitude controllers exhibit an additional phase and magnitude setting, the additional signal beam having a second AOD greater than the first AOD; and
transmitting, using the transmitter, additional wireless signals over the additional signal beam while the phase and magnitude controllers exhibit the additional phase and magnitude setting, wherein
transmitting the wireless signals over the signal beam includes transmitting the wireless signals using a primary component carrier (PCC) and a secondary component carrier (SCC), and
transmitting the additional wireless signals over the additional signal beam includes transmitting the wireless signals using the PCC.

16. The method of claim 15, wherein transmitting the additional wireless signals comprises transmitting the additional wireless signals using an additional SCC, the PCC being closer to the additional SCC than to the SCC.

17. The method of claim 11, wherein the signal beam has a first angle-of-departure (AOD) and a first beam width, the method further comprising:
forming, using the phase and magnitude controllers, an additional signal beam while the phase and magnitude controllers exhibit an additional phase and magnitude setting, the additional signal beam having a second AOD greater than the first AOD; and
transmitting, using the transmitter, additional wireless signals over the additional signal beam while the phase and magnitude controllers exhibit the additional phase and magnitude setting, wherein the additional signal beam has a second beam width different than the first beam width.

18. A method of operating an electronic device, the method comprising:
forming, using phase and magnitude controllers of a phased antenna array, a receive beam while the phase and magnitude controllers exhibit a phase and magnitude setting;
performing, using a receiver coupled to the phased antenna array, a first measurement of a first sub-band of reference signals transmitted by an external device while the phase and magnitude controllers exhibit the phase and magnitude setting;
performing, using the receiver, a second measurement of a second sub-band of the reference signals while the phase and magnitude controllers exhibit the phase and magnitude setting; and
transmitting, to the external device, a measurement report associated with the first measurement and the second measurement.

19. The method of claim 18, further comprising:
receiving, using the phased antenna array, the first sub-band of the reference signals while the external device transmits the reference signals using a first transmit beam, the first measurement being performed on the reference signals transmitted using the first transmit beam; and
receiving, using the phased antenna array, the second sub-band of the reference signals while the external device transmits the reference signals using the first transmit beam, the second measurement being performed on the reference signals transmitted using the first transmit beam.

20. The method of claim 19, further comprising:
forming, using the phase and magnitude controllers, an additional receive beam while the phase and magnitude controllers exhibit an additional phase and magnitude setting;
receiving, using the phased antenna array, additional reference signals transmitted by the external device using a second transmit beam different from the first transmit beam;
performing, using the receiver, a third measurement of the first sub-band of the additional reference signals while the phase and magnitude controllers exhibit the additional the phase and magnitude setting; and
performing, using the receiver, a fourth measurement of the second sub-band of the additional reference while the phase and magnitude controllers exhibit the additional phase and magnitude setting.
